(19) United States
(12) Patent Application Publication
(10) Pub. No.: US 2026/0257332 A1
(43) Pub. Date: Sep. 3, 2026

(54) START-UP ALGORITHMS

(71) Applicant: Black & Decker Inc., New Britain, CT (US)

(72) Inventors: Tim Heimrich, Bad Camberg (DE); Sami Sahli, Idstein (DE); Fridtjof Krische, Mainz (DE)

(21) Appl. No.: 19/539,267

(22) Filed: Feb. 13, 2026

Related U.S. Application Data
(63) Continuation of application No. PCT/EP2023/072939, filed on Aug. 21, 2023.

(51) Int. Cl. B25F 5/00; G05B 13/02

(52) U.S. Cl. CPC B25F 5/001; G05B 13/026

(57) ABSTRACT

A start up method for an electric motor configured to drive a mechanical load in a reciprocating or oscillating cycle, the method being for use in a power tool and comprising: setting a first target speed ramp for the motor having a first gradient; monitoring a drive parameter indicative of the power and/or torque generated by the motor; detecting a maximum in the drive parameter; and in response to detecting the maximum, setting a second target speed ramp for the motor having a second gradient that is greater than the first gradient.

### CROSS-REFERENCE TO RELATED APPLICATION

The present application is a continuation of International Patent Application No. PCT/EP2023/072939, filed on Aug. 21, 2023, entitled START-UP ALGORITHMS, and claims the benefit of priority thereof under 35 U.S.C. § 120.

### INCORPORATION BY REFERENCE

The disclosure of International Patent Application No. PCT/EP2023/072939, filed on Aug. 21, 2023, entitled START-UP ALGORITHMS, is hereby incorporated by reference for all purposes as if set forth in its entirety.

### TECHNICAL FIELD

The present disclosure relates to control methods for an electric motor driving a reciprocating or oscillating load. In particular, the present disclosure relates to battery powered compacting power tools, such as rammers.

### BACKGROUND

Some power tools include a motor for driving a reciprocating or oscillating load. These are often used to perform compacting tasks such as compacting soil, asphalt or hardcore, or hammering tasks such as breaking up concrete (e.g. a jack hammer). An example of a compacting power tool is a rammer which comprises a reciprocating foot which impacts and flattens the surface to be compacted. A rammer may also be known as a tamper, a soil compactor, a compactor, a jumping jack compactor, a jumping jack tamper, a plate compactor, or a vibratory plate. Rammers generally comprise a combustion engine or electric motor for driving the reciprocating plate or foot.

Typically, the reciprocating or oscillating mechanism of such power tools (e.g. a rammer) includes one or more springs arranged to store and release energy during the reciprocating/oscillating cycle. This can cause complex and erratic movement of the reciprocating or oscillating mechanism during acceleration of the motor, e.g. during startup. Furthermore, the weight of the power tool can be a significant factor during operation of the tool when the tool itself moves in response to movement of its reciprocating/oscillating mechanism. This can lead to uneven power requirements from the motor throughout the reciprocation/oscillation cycle, which are particularly significant during startup.

The above issues can lead to aggressive and erratic movement during the startup of power tools that drive a reciprocating or oscillating load. In rammers, especially rammers with combustion engines, a centrifugal clutch is sometimes used between the motor and reciprocating mechanism to smooth the tool behaviour during startup. However, such clutches are heavy and, due to constant wear, need regular maintenance.

### SUMMARY

There is provided a start up method for an electric motor configured to drive a mechanical load in a reciprocating or oscillating cycle, the method being for use in a power tool and comprising: setting a first target speed ramp for the motor having a first gradient; monitoring a drive parameter indicative of the power and/or torque generated by the motor; detecting a maximum in the drive parameter; and in response to detecting the maximum, setting a second target speed ramp for the motor having a second gradient that is greater than the first gradient.

The motor may be coupled to a reciprocating drive mechanism of the power tool such that, in use, rotation of the motor corresponds to movement of the mechanical load through the reciprocating cycle.

The power tool may be a compacting power tool without a clutch between the motor and the reciprocating drive mechanism.

The mechanical load may comprise, in use, one or more of: mechanical load of a compacting foot of the compacting power tool on a surface to be compacting; mechanical load of one or more biasing elements of the reciprocating drive mechanism; weight of at least part of the compacting power tool.

The power tool and/or its load may be configured such that, in use at a steady-state motor speed, the input power to the motor required to maintain the steady-state motor speed varies over the reciprocating or oscillating cycle.

The power tool may comprise one or more biasing elements arranged to store and release energy during the reciprocating or oscillating cycle driven by the motor.

The action of the one or more biasing elements during the reciprocating or oscillating cycle may cause a variation in motor speed over the reciprocating or oscillating cycle for a fixed power input from the motor.

The one or more biasing elements may include one or more springs, elastomers, dampers, and elastic members.

In use, the action of gravity on the power tool during the reciprocating or oscillating cycle may cause a variation in motor speed over the reciprocating or oscillating cycle.

The method may further comprise controlling commutation of the motor in accordance with the target speed according to the first/second target speed ramp.

The motor may be a three-phase motor and the controlling commutation of the motor is performed according to a Field-Oriented Control (FOC) scheme, Trapezoidal 6-step control scheme, or a V/Hz control scheme.

The motor may include a plurality of windings and the controlling commutation of the motor is performed by controlling phase currents through the windings.

The motor may include a rotor and one or more sensors for measuring phase currents through the windings, the controlling the commutation of the motor being performed in dependence on rotor orientation inferred from the measured phase currents.

The motor may include a rotor and a position sensor configured to measure rotor orientation, the controlling the commutation of the motor is performed in dependence on the measured rotor orientation.

The position sensor may be a Hall sensor or rotary encoder.

The control logic may be configured to receive at least one signal associated with phase currents of the motor and determine rotor orientation based on the phase currents of the motor.

The rotor orientation may be inferred from the phase currents by using the phase currents to calculate a back-EMF and determining the rotor orientation from the calculated back-EMF.

The motor may be a brushless motor.

The setting of the second target speed ramp may be performed independently of a measured speed of the motor.

The gradient of the second target speed ramp may be at least twice the gradient of the first target speed ramp, or at least five times the gradient of the first target speed ramp.

The gradients of the first and second target speed ramps may have an average rate of change of the respective target speed ramp over a predetermined period of time or the period of time over which the respective target speed ramp applies to the motor.

The first and/or second target speed ramps may represent linear or non-linear functions describing a variation of the motor speed over time.

The drive parameter may be one or more of a current through the motor, an electrical power input to the motor, a mechanical power output from the motor, a mechanical torque from the motor, and an envelope representing the amplitude of phase currents through the motor windings.

The drive parameter may be a quadrature current I_{q} in the rotating frame of reference of the motor synchronous with the rotor flux.

The detecting a maximum in the drive parameter may comprise: filtering the drive parameter so as to suppress and/or remove variations in the drive parameter above a predetermined frequency; and identifying a maximum of the drive parameter.

The predetermined frequency may be at least twice the steady state frequency of the motor in use when driving its mechanical load in the reciprocating or oscillating cycle.

The identifying a maximum of the drive parameter may comprise: detecting a rate of change of zero in the drive parameter; and confirming that the zero rate of change of the drive parameter represents a maximum of the drive parameter.

The method may further comprise, subsequent to setting the second target speed ramp, setting a steady-state target speed for the motor when the motor reaches a predetermined speed.

The steady-state target speed may be user selectable.

The predetermined speed may be the steady-state target speed.

The motor may comprise a rotor and the method further comprises, in an initial phase prior to setting the first target speed ramp: performing initial detection of the rotor orientation; and controlling commutation of the motor in dependence on the detected rotor orientation.

The controlling commutation may be performed according to the first target speed ramp.

The setting the first target speed ramp may be performed when the motor reaches a second predetermined speed.

The setting the first target speed ramp may be performed so as to start the first target speed ramp at the second predetermined speed of the motor.

There is provided a power tool comprising: an electric motor; a reciprocating or oscillating drive mechanism coupled to the motor for driving a mechanical load in a reciprocating or oscillating cycle; and control logic configured to, during startup of the motor: set a first target speed ramp for the motor having a first gradient; monitor a drive parameter indicative of the power and/or torque generated by the motor; detect a maximum in the drive parameter; and in response to detecting the maximum, set a second target speed ramp for the motor having a second gradient that is greater than the first gradient.

The motor may be coupled to the reciprocating or oscillating drive mechanism such that, in use, rotation of the motor corresponds to movement of the load through the reciprocating or oscillating cycle.

The power tool may be a compacting power tool comprising a housing in which the motor is mounted, and the reciprocating drive mechanism is configured to, in use when the motor is rotating, move a compacting foot between a first position and a second position.

The reciprocating drive mechanism may include an eccentric drive wheel, the motor being coupled to the eccentric drive wheel such that rotation of the motor drives reciprocal motion of the compacting foot.

The compacting power tool may not include a clutch between the motor and the reciprocating drive mechanism.

In use, the motor may drive a mechanical load comprising one or more of: mechanical load of the compacting foot on a surface to be compacting; mechanical load of one or more biasing elements of the reciprocating drive mechanism; weight of at least part of the compacting power tool.

The second gradient at all points of the second target speed ramp may be greater than the first gradient at all points of the first target speed ramp.

There is provided a start up method for an electric motor configured to drive a mechanical load in a reciprocating or oscillating cycle, the method being for use in a power tool and comprising: setting a first target speed ramp for the motor having a first gradient; monitoring a drive parameter indicative of the power and/or torque generated by the motor; detecting a minimum in the drive parameter; and in response to detecting the minimum, setting a second target speed ramp for the motor having a second gradient that is lower than the first gradient.

There is provided a start up method for an electric motor configured to drive a mechanical load in a reciprocating or oscillating cycle, the method being for use in a power tool and comprising: monitoring a drive parameter indicative of the power and/or torque generated by the motor over the reciprocating or oscillating cycle; and within each reciprocating or oscillating cycle: in response to the drive parameter indicating that the power and/or torque generated by the motor exceeds a first threshold, setting a first target speed for the motor; and in response to the drive parameter indicating that the power and/or torque generated by the motor is below a second threshold, setting a second target speed for the motor; wherein the second target speed is higher than the first target speed.

The first and/or second thresholds may be dynamically determined in dependence on the speed of rotation of the motor.

The first target speed may be set to a determined or measured speed of rotation of the motor.

The first target speed may be set according to a first target speed ramp, the first target speed ramp representing a variation of the first target speed over time.

The second target speed may be set to a steady state speed of the motor to be achieved, in use, when the reciprocating or oscillating cycle is in its steady state.

The first and second thresholds may have the same value.

The motor may be coupled to a reciprocating drive mechanism of the power tool such that, in use, rotation of the motor corresponds to movement of the mechanical load through the reciprocating cycle.

The power tool may be a compacting power tool without a clutch between the motor and the reciprocating drive mechanism.

The compacting power tool may include a compacting foot arranged to, in use on performing each reciprocating cycle, move from a first position to a second position and back to the first position.

The mechanical load may comprise, in use, one or more of: mechanical load of a compacting foot of the compacting power tool on a surface to be compacting; mechanical load of one or more biasing elements of the reciprocating drive mechanism; weight of at least part of the compacting power tool.

The power tool and/or its load may be configured such that, in use at a steady-state motor speed, the input power to the motor required to maintain the steady-state motor speed varies over the reciprocating or oscillating cycle.

The power tool may comprise one or more biasing elements arranged to store and release energy during the reciprocating or oscillating cycle driven by the motor.

In use, the action of the one or more biasing elements during the reciprocating or oscillating cycle may cause a variation in motor speed over the reciprocating or oscillating cycle.

The one or more biasing elements may include one or more springs, elastomers, dampers, and elastic members.

In use, the action of gravity on the power tool during the reciprocating or oscillating cycle may cause a variation in motor speed over the reciprocating or oscillating cycle.

The method may further comprise controlling commutation of the motor in accordance with the first and second target speeds.

The controlling commutation of the motor may be performed according to a Field-Oriented Control (FOC) scheme, Trapezoidal 6-step control scheme, or a V/Hz control scheme.

The motor may include a plurality of windings and the controlling commutation of the motor is performed by controlling phase currents through the windings.

The motor may include a rotor and one or more sensors for measuring phase currents through the windings, the controlling the commutation of the motor being performed in dependence on rotor orientation inferred from the measured phase currents.

The motor may include a rotor and a position sensor configured to measure rotor orientation, the controlling the commutation of the motor is performed in dependence on the measured rotor orientation.

The position sensor may be a Hall Encoder or rotary encoder.

The control logic may be configured to receive at least one signal associated with phase currents of the motor and determine rotor orientation based on the phase currents of the motor.

The rotor orientation may be inferred from the phase currents by using the phase currents to calculate a back-EMF and determining the rotor orientation from the calculated back-EMF.

The motor may be a brushless motor.

The first and/or second target speeds may be linear or non-linear functions describing a target variation of the motor speed over time.

The drive parameter may be one or more of a current through the motor, an electrical power input to the motor, a mechanical power output from the motor, a mechanical torque output from the motor, an envelope representing the amplitude of phase currents through the motor windings, an acceleration of a drive mechanism of the power tool which is driven by the motor, and a rotor orientation of the motor.

The drive parameter may be a quadrature current I_{q} in the rotating frame of reference of the motor synchronous with the rotor flux.

The method may further comprise, subsequent to setting the second target speed, setting a steady-state target speed for the motor when the motor reaches a predetermined speed.

The predetermined speed may be the steady-state target speed.

The motor may comprise a rotor and the method may further comprise, in an initial phase prior to setting the first target speed: performing initial detection of the rotor orientation; and controlling commutation of the motor in dependence on the detected rotor orientation.

The monitoring the drive parameter may begin when the motor reaches a predetermined speed.

There is provided a power tool comprising: an electric motor; a reciprocating or oscillating drive mechanism coupled to the motor for driving a mechanical load in a reciprocating or oscillating cycle; and control logic configured to, during startup of the motor: monitor a drive parameter indicative of the power and/or torque generated by the motor over the reciprocating or oscillating cycle; and within each reciprocating or oscillating cycle: in response to the drive parameter indicating that the power and/or torque generated by the motor exceeds a first threshold, set a first target speed for the motor; and in response to the drive parameter indicating that the power and/or torque generated by the motor is below a second threshold, set a second target speed for the motor; wherein the second target speed is higher than the first target speed.

The motor may be coupled to the reciprocating or oscillating drive mechanism such that, in use, rotation of the motor corresponds to movement of the load through the reciprocating or oscillating cycle.

The power tool may be a compacting power tool comprising a housing in which the motor is mounted, and the reciprocating or oscillating drive mechanism is configured to, in use when the motor is rotating, move a compacting foot between an extended position and a retracted position.

The drive parameter may be rotor orientation and: the rotor orientation indicates that the power and/or torque generated by the motor exceeds a first threshold when the rotor orientation lies within a first range corresponding to the compacting foot moving from the retracted position to the extended position and the housing moving against gravity; and the rotor orientation indicates that the power and/or torque generated by the motor is below a second threshold when the rotor orientation lies within a second range corresponding to the compacting foot moving from the extended position to the retracted position and the housing moving with gravity.

The reciprocating drive mechanism may include an eccentric drive wheel, the motor being coupled to the eccentric drive wheel such that rotation of the motor drives reciprocal motion of the compacting foot.

The compacting power tool may not include a clutch between the motor and the reciprocating drive mechanism.

In use, the motor may drive a mechanical load comprising one or more of: mechanical load of the compacting foot on a surface to be compacting; mechanical load of one or more biasing elements of the reciprocating drive mechanism; weight of at least part of the compacting power tool.

There is provided a compacting power tool comprising: a brushless motor having a plurality of windings and a rotor; a reciprocating drive mechanism coupled to the motor and configured to, in use, drive a compacting foot in a reciprocating cycle from a first position to a second position and back to the first position; a power switch circuit that supplies power from a power source to the brushless motor; and control logic configured to receive at least one signal associated with a phase current of the motor, detect an angular position of the rotor based on the phase current of the motor, and apply a drive signal to the power switch circuit to control commutation of the motor based on the detected angular position of the rotor.

The control logic may be configured to detect an initial sector of a plurality of motor sector positions within which the rotor is located at start-up, apply the drive signal so as to rotate the rotor to a parking angle associated with the detected initial sector, and control a commutation sequence to drive the motor beginning at the parking angle.

The control logic may be configured to apply a high-frequency injection (HFI) step of injecting a plurality of voltage pulses to the motor and detecting corresponding high-frequency current components to determine the angular position of the rotor.

The control logic may be further configured to control the commutation sequence of the motor in open loop and without reference to the angular position of the rotor during a transition period after the motor is parked at the parking angle and before the HFI step.

During the transition period, the control logic may apply the plurality of voltage pulses to the motor, detects the corresponding high-frequency current components to estimate a rotor angle, and compares the estimated rotor angle to the parking angle to determine the angular position of the rotor.

The control logic may be configured to calculate a motor speed based on the angular position of the rotor and transition from the HFI step to a sliding-mode observer (SMO) step when the motor speed exceeds a threshold.

In the SMO step, the control logic may be configured to estimate a back electromotive force (back-EMF) voltage of the motor based on phase currents of the motor and determine the angular position of the rotor based on the estimated back-EMF voltage.

The parking angle may be selected from a plurality of parking angles disposed 60-degrees apart.

The drive signal may be applied so as to rotate the motor to the parking angle for approximately 10 to 200 milliseconds.

When a rotor speed is below a speed threshold, the control logic may be configured to apply a high-frequency injection (HFI) step of injecting a plurality of voltage pulses to the motor and detecting corresponding high-frequency current components to make a first estimation of the angular position of the rotor and, when the rotor speed is above a speed threshold, the control logic is configured to apply a sliding-mode observer (SMO) step of estimating a back electromotive force (back-EMF) voltage of the motor based on phase currents of the motor and making a second estimation of the angular position of the rotor based on the estimated back-EMF voltage.

When the rotor speed exceeds the speed threshold, the control logic may be configured to commutate the motor according to the first estimation of the angular position, gradually modify the commutation of the motor until the first estimation of the angular position substantially matches the second estimation of the angular position, and commutate the motor according to the second estimation of the angular position thereafter.

The control logic may be configured to gradually ramp down the HFI step after the rotor speed exceeds the speed threshold.

When the rotor speed exceeds the speed threshold, the control logic may be configured to concurrently apply the HIF and SMO steps for approximately 1 to 5 milliseconds.

The control logic may be configured to gradually modify the commutation of the motor until the first estimation of the angular position is within a margin of error of the second estimation of the angular position.

In the SMO step, the control logic may calculate the back-EMF voltage of the motor as a function of the drive signal, phase currents of the motor, and a DC bus voltage input to the power switch circuit.

In the SMO step, the control logic may calculate the back-EMF voltage of the motor as a function of motor phase voltage signals and the phase current of the motor.

The motor may be coupled to the reciprocating drive mechanism such that, in use, rotation of the motor corresponds to movement of the mechanical load through the reciprocating cycle.

The compacting power tool may not include a clutch between the motor and the reciprocating drive mechanism.

The control logic may be configured to operate the motor at a maximum speed of no more than 4000 rpm.

The compacting power tool may comprise one or more biasing elements arranged to store and release energy during the reciprocating or oscillating cycle driven by the motor.

The one or more biasing elements may include one or more springs, elastomers, dampers, and elastic members.

The brushless motor may be an outer rotor motor.

The compacting power tool may be a rammer or plate compactor.

The above features may be combined as appropriate, as would be apparent to a skilled person, and may be combined with any of the aspects of the examples described herein.

### BRIEF DESCRIPTION OF THE DRAWINGS

Examples will now be described in detail with reference to the accompanying drawings in which:

FIG. 1 shows an electric rammer.

FIG. 2 is a cross-section along axis A-A through the rammer of FIG. 1.

FIG. 3 shows a reciprocating drive mechanism and motor control apparatus in accordance with the examples described herein.

FIGS. 4A and 4B illustrate the problematic behaviour during startup of an electric rammer without a centrifugal clutch.

FIG. 5 illustrates the behaviour during startup of an electric rammer controlled in accordance with the startup algorithms described herein.

FIG. 6 shows an exemplary configuration of control logic for performing the startup algorithms described herein.

FIG. 7 is a flowchart illustrating a startup algorithm in accordance with the principles described herein.

FIGS. 8A and 8B illustrate the behaviour during startup of an electric rammer controlled in accordance with the alternative startup algorithms described herein.

FIGS. 9A and 9B compare the behaviour during startup of a conventional electric rammer against an electric rammer controlled in accordance with the alternative startup algorithms described herein.

FIG. 10 is a flowchart illustrating alternative startup algorithms in accordance with the principles described herein.

FIG. 11 depicts a speed-time diagram depicting exemplary procedures implemented by control logic to determine rotor position from start-up to full speed.

FIG. 12 depicts a flow diagram for a process corresponding to FIG. 11.

FIG. 13 depicts an exemplary excitation sequence table including high-side and low-side drive signals corresponding to rotor angles VI-V6 within a full rotation of the rotor, according to an embodiment.

FIG. 14 depicts a diagram representing a full 360-degree orientation of the rotor angles from VI through V6.

FIG. 15 depicts an exemplary diagram showing measured currents corresponding to each pulse injection for Initial Position Detection (IPD).

FIG. 16 depicts an alternative excitation sequence table including high-side and low-side drive signals corresponding to rotor angles VI-V6 within a full rotation of the rotation of the rotor.

FIG. 17 depicts a diagram representing a full 360-degree orientation of the rotor angles from VI through V6 with the rotor parked at 30-degree intervals.

FIG. 18 depicts a partial block system diagram of the power tool using High-Frequency Injection (HFI) for low-speed control.

FIG. 19 depicts a block system diagram of an HFI-based position estimator, according to an embodiment.

FIG. 20 depicts a current waveform diagram showing the three phase currents Iv, Iu, Iw in low-speed control.

FIG. 21 depicts a flow diagram of an exemplary process executed for determining the correct rotor angle 8 at start-up using HFI and parking.

FIG. 22 depicts a zoomed-in view of FIG. 20 showing the three phase currents Iv, Iu, Iw as controller executes closed-loop HFI for low-speed motor operation.

FIG. 23 depicts a flow diagram of an exemplary process executed by controller for transition from low-speed control.

FIG. 24 depicts an exemplary partial block system diagram of the power tool using a Sliding-Mode Observer (SMO) for rotor position detection.

FIG. 25 depicts an exemplary block system diagram of SMO-based position estimator of FIG. 24.

FIG. 26 depicts an exemplary partial block system diagram of the power tool in using an alternative Sliding-Mode Observer (SMO) for rotor position detection.

FIG. 27 depicts an exemplary block system diagram of SMO-based position estimator of FIG. 26.

The accompanying drawings illustrate various examples. Common reference numerals are used throughout the figures, where appropriate, to indicate similar features.

### DETAILED DESCRIPTION

The following description is presented by way of example to enable a person skilled in the art to make and use the invention. The present invention is not limited to the embodiments described herein and various modifications to the disclosed embodiments will be apparent to those skilled in the art.

The present disclosure describes a rammer by way of example. More generally the power tool may be any kind of power tool arranged to drive a reciprocating or oscillating load, such as jack hammers, plate compactors, and the like.

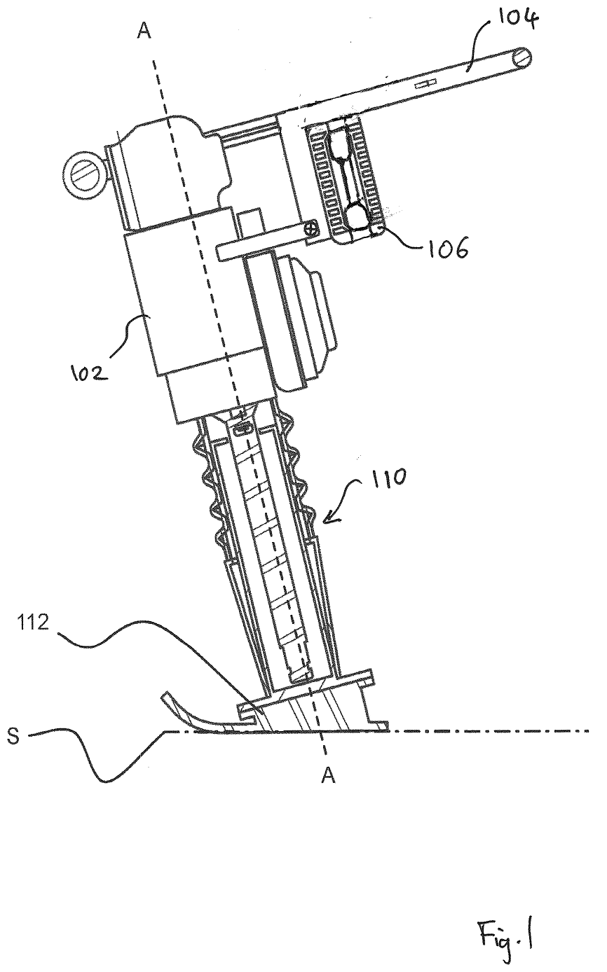

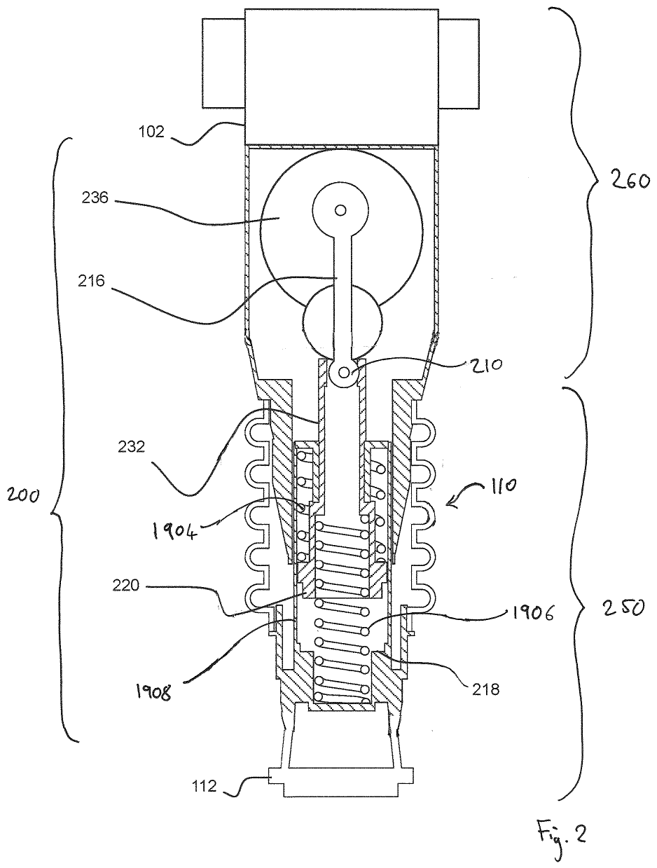

As an example of a power tool arranged to drive a reciprocating load, FIG. 1 shows an electric rammer 100 comprising a primary housing 102 and a reciprocating leg portion 110 which is coupled to a compacting foot 112. The compacting foot 112 is adapted for compacting soil, hardcore, asphalt or any other material S to be compacted. The reciprocating leg portion comprises a reciprocating mechanism (shown in FIG. 2) which is arranged to drive the compacting foot up and down along the longitudinal axis A-A of the tool. The rammer includes a handle 104 by which a user can manoeuvre the rammer, and a battery pack 106 for powering the electric motor of the rammer (located within the primary housing 102).

FIG. 2 is a cross-section along axis A-A through the rammer of FIG. 1 and shows the reciprocating mechanism 200 located within the primary housing 102 and reciprocating leg portion 110. The reciprocating mechanism 200 comprises a connecting rod 216 which is connected between an eccentric drive wheel 236 which is driven by an electric motor (not shown in the figure). The connecting rod 216 is configured to move a reciprocating piston 232 between a retracted position where a first end 220 of the reciprocating piston 232 is moved towards the primary housing 102 and an extended position where the first end 220 of the reciprocating piston 232 is moved away from the primary housing 102.

The connecting rod 216 and the reciprocating piston 232 are arranged to move along the longitudinal axis A-A within a piston cylinder 1908. The piston cylinder 1908 receives and guides the movement of the reciprocating piston 232 when moving along the longitudinal axis A-A. The distal end 218 of the piston cylinder 1908, located away from the primary housing 102, is connected to the compacting foot 112 such that movement of the reciprocating mechanism 200 results in movement of the compacting foot 112.

In some examples, the reciprocating piston 232 is coupled to a spring assembly comprising a first spring 1904 and a second spring 1906. When the rammer 100 is not operational, the reciprocating mechanism 200 rests in the position as shown in FIG. 2. This position is dependent on the weight of the rammer and the balance of the upper and lower springs 1904 and 1906 of the spring assembly. The first spring 1904 acts in opposition to movement of the reciprocating piston 232 away from the compacting foot 112 and towards the retracted position. In this way, the first spring 1904 urges the reciprocating piston 232 to towards the compacting foot 112 and the extended position. The second spring 1906 acts in opposition to movement of the reciprocating piston 232 towards the compacting foot 112 and towards the extended position. In this way, the second spring 1906 urges the reciprocating piston 232 away from the compacting foot 112 and towards the retracted position.

The arrangement of springs 1904 and 1906 in FIG. 2 is merely one example. Rammers may in general use any suitable arrangement of one or more biasing elements (e.g. springs, elastomers, dampers, etc.) to control movement of the reciprocating piston 232.

The up and down movement of the reciprocating piston 232 along the A-A axis due to rotation of the electric motor driving the eccentric drive wheel 236 causes the first and second springs 1904, 1906 alternately expand and compress. Accordingly, the compacting foot 112 reciprocates up and down so as to provide a compacting force to the surface to which the rammer is applied.

The reciprocating leg portion 110 (comprising the piston cylinder 1908 and spring assembly) and the reciprocating foot 112 form a lower mass assembly 250 which reciprocates with respect to an upper mass assembly 260. The upper mass assembly 260 is formed by the remaining components of the rammer 100 in the primary housing 102 (e.g. its motor, eccentric wheel drive, battery pack, etc.). In other words, the lower mass assembly 250 includes those parts of the rammer connected to end 210 of the connecting rod 216 and which therefore move in a reciprocal motion relative to the upper mass assembly 260. The upper mass assembly 260 is in some examples is all the other components which are not part of the lower mass assembly 250.

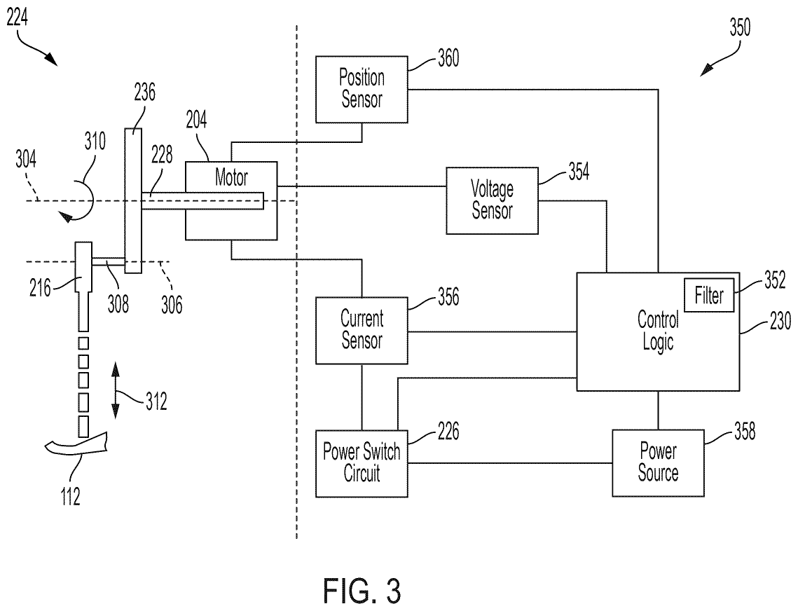

As shown in FIG. 2, the connecting rod 216 is connected between the reciprocating piston 232 and the eccentric drive wheel 236. The eccentric drive wheel 236 is part of a drive mechanism 224 which is shown in cross-section on the left hand side of FIG. 3. The drive mechanism 224 is arranged to generate the reciprocating movement of the lower mass assembly 250 with respect to the upper mass assembly 260. The drive mechanism 224 is rotatably coupled to a drive shaft 226 of an electric motor 204. In the example shown in FIG. 3, the motor 204 is directly coupled to the eccentric drive wheel 236. In other examples, a transmission (e.g. one or more gears) is provided between the electric motor 204 and the eccentric drive wheel 236.

In some examples, the eccentric drive wheel 236 may be coupled to the drive shaft 226 of the motor 204 via a pinion gear mounted on the drive shaft 226 which is arranged to engage with a toothed outer surface (not shown) of the eccentric drive wheel 236 so as to rotate the drive wheel.

In FIG. 3, the eccentric drive wheel 236 is arranged to rotate about a central axis 304 and the connecting rod 216 is rotatably coupled to the eccentric drive wheel 236 by means of a pin 308. The pin 308 is offset from the central axis 304 of the drive wheel such that rotation 310 of the drive wheel causes the connecting rod to reciprocate up and down 312. In other words, the drive mechanism 224 converts the rotational movement 310 provided by the electric motor 204 into a reciprocating movement 312 for driving the reciprocating mechanism 200.

Various other mechanical arrangements for converting a rotational movement into a reciprocating movement are known in the art and any suitable such arrangement may be used.

During start up in an electric rammer with an electric motor, due to the heavy weight of the tool body, gravity plays a role in the amount of current that is drawn by the motor, and therefore the speed ramp-up behavior of the motor. When the tool body is moving down, the motor consumes less power (i.e., low power consumption periods), and when the tool body is moving up against the force is gravity, the motor consumes significantly more power (i.e., high power consumption periods). This, along with the spring system in the rammer, will typically cause complex and erratic jumping behavior during ramp-up of the motor speed at start up of the tool. At startup, a rammer can therefore exhibit aggressive and erratic movement, which makes the handling of the unit more difficult, can cause injury to the user, and increases wear on the moving parts of the rammer. Furthermore, the erratic motion of the rammer is a result of the rotational power provided by the motor being inefficiently coupled to the reciprocating mechanism of the rammer and so a significant amount of energy can be wasted during startup. This is of particular concern for battery powered rammers.

It will be appreciated that the action of gravity on the tool body and/or the action of its spring system (or more generally, any biasing elements of the reciprocating mechanism) may have the result that, in use at a steady-state motor speed, the input power to the motor required to maintain the steady-state motor speed varies over the reciprocating cycle.

To mitigate these problems, new startup control methods are proposed. The control methods described herein relate in particular to brushless motors for rammers, such as brushless direct current (BLDC) motors and induction motors, in which the motor is directly coupled (which may be via an optional transmission, e.g. a reduction gear) to a reciprocating mechanism without a clutch (e.g. a centrifugal clutch). In this manner, rotation of the motor corresponds to movement of the reciprocating mechanism and its mechanical load through the reciprocating cycle. Typically brushless motors have three phases, but different numbers of phases may be used (e.g. 6 phases).

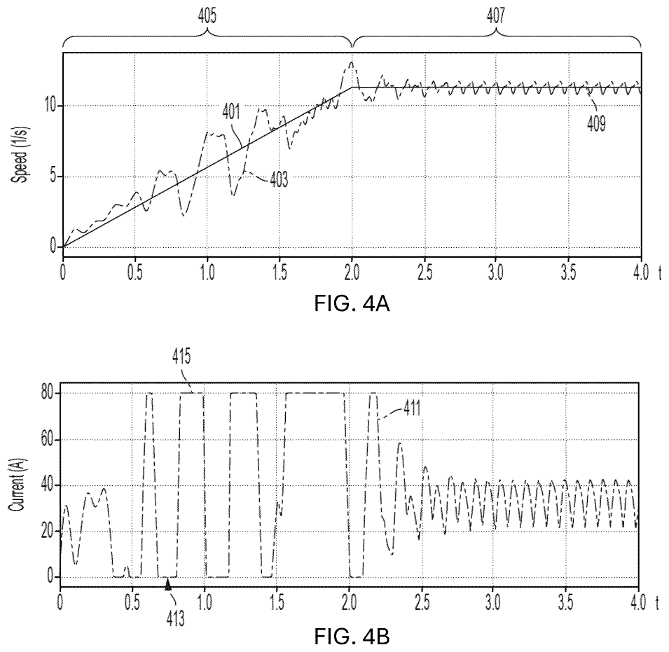

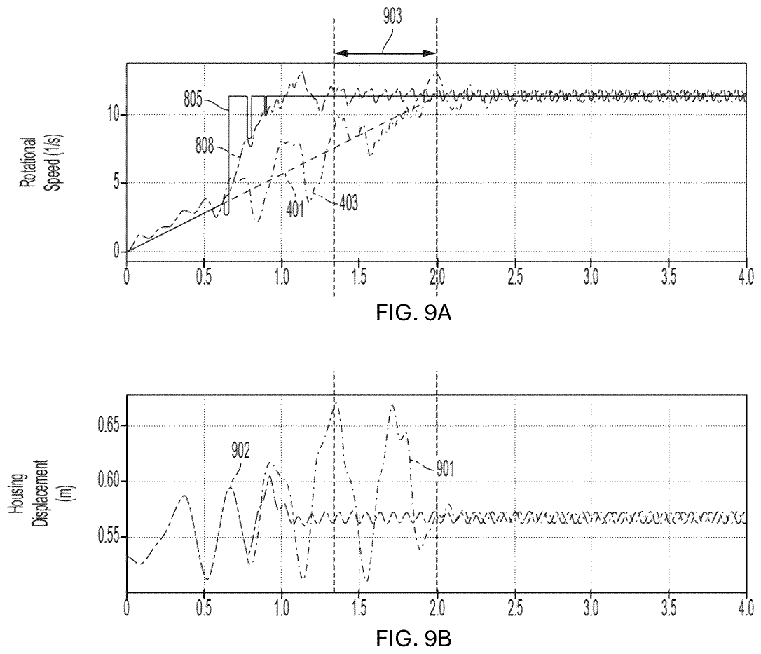

FIGS. 4A and 4B illustrate in more detail the problematic behaviour during startup of an electric rammer without a centrifugal clutch. FIG. 4A is a plot of the target speed 401 for the electric motor of a rammer (e.g. which the control unit of the motor attempts to achieve) against time. During startup phase 405, the target speed 401 is a simple ramp from zero up to the steady state speed 409 of the rammer in the steady state phase 407. The actual rotational speed 403 of the electric motor which is achieved is included in FIG. 4A. It will be observed that the actual rotation speed of the motor during startup phase 405 is erratic and varies significantly about the target speed and sometimes substantially exceeds or falls short of the target smooth ramp during startup. The erratic and aggressive behaviour of the rammer can, in particular, be appreciated from the plot of the housing displacement 901 shown in FIG. 9B which represents the movement of the upper housing of a conventional rammer during startup in the absence of a centrifugal clutch. The aggressive movement of the upper housing of the rammer is experienced by the rammer operator during startup since the handle for controlling the rammer is coupled to the upper housing.

FIG. 4B is a plot of the current 411 through the motor against time over the same time period shown in FIG. 4A. It will be observed that the current oscillates to an extreme degree during the startup phase 405 between zero current 413 and maximum current 415. This is a consequence of the spring assembly (i.e. storing and returning translational kinetic energy of the lower mass assembly 250) and the weight of the upper mass assembly. When the upper mass assembly is moving down, the motor consumes less power (i.e., low power consumption periods), and when the upper mass assembly is moving up against the force is gravity, the motor consumes significantly more power (i.e., high power consumption periods. There is a complex interplay between the action of gravity and the spring assembly which leads to the relatively erratic changes in current through the motor effected by the motor control unit as it tries to achieve the target rotational speed 401.

It will be appreciated that not only is the movement 901 of the upper housing of the rammer illustrated in FIG. 9B erratic and potentially dangerous during startup, there are periods of very high (typically maximal) current flow and the total power consumed during the startup phase is high.

### Startup Algorithm

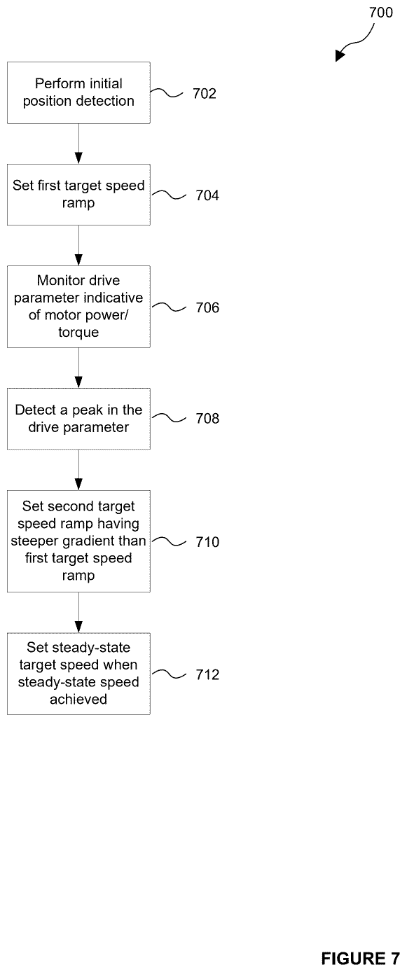

Motor control apparatus 350 for controlling the motor 204 according to the startup algorithms taught herein is shown on the right-hand side of FIG. 3. An exemplary startup algorithm 700 is shown in FIG. 7. Typically for power tools, the motor will be a brushless motor which requires an electronic controller (e.g. control logic 230) to control currents through the motor windings (typically the stator) so as to produce magnetic fields which drive the rotor (typically a permanent magnet) to rotate. By adjusting the phase and amplitude of the current pulses, the speed and torque provided by the motor may be controlled. In this manner, the control logic 230 is configured to perform commutation: that is, the control logic controls the switches of the power switch circuit 226 to switch the currents to the motor windings so as to cause the magnetic fields to rotate based on the position of the rotor. The control logic adapts the magnetic fields so as to effect a force on the rotor in the desired rotational sense—e.g. to accelerate or decelerate the motor, or to maintain a constant rotational speed for the load being driven by the motor. In some examples, the motor is a Brushless DC Electric (BLDC) motor.

In some examples, motor 204 may be an outer-rotor motor (or external rotor motor). In an outer-rotor motor, the rotor magnets are provided on an outer cup that is rotatable around a stator core. The outer cup includes a plate on one side of the stator that is secured to a rotor shaft. An outer rotor is capable of providing higher magnetic flux and is also capable of producing more torque than a comparable inner rotor motor.

For motors other than BLDC motors, the control logic 230 may be configured to perform commutation according to the requirements of that motor system, as will be understood by those skilled in the art of electric motor control.

The control logic may be any suitable control unit: for example, it may comprise one or more of fixed logic hardware (e.g. an Application Specific Integrated Circuit, or ASIC), firmware, and software running on a processor.

In order for the control logic 230 to cause appropriate currents to be applied to the motor windings, the control logic must know the orientation of the motor's rotor relative to its stator coils. This may be achieved through the use of a position sensor 360 (which would typically be provided at the motor 204, e.g. as a Hall Effect sensor or rotary encoder) and/or the control logic may infer the position of the rotor by measuring the phase and/or amplitude of the voltage and/or currents induced in the motor coils—for example, by measuring the back EMF of the undriven coils of the motor as is known in the art, or through the use of Field-Oriented Control (FOC) algorithms which are described below.

To enable the control logic 230 to control the operation of the motor 204, the motor control apparatus 350 further includes a current sensor 356 to measure the phase currents through the motor windings. Typically the motor will have three stator windings with the current through each winding representing one of three phase currents, but in some examples a larger or smaller number of windings (and hence phase currents) may be provided. The motor control apparatus may further include a voltage sensor 354 for measuring the voltages applied across the motor windings.

The current sensor 356 may perform the measurement of the phase currents in any suitable manner. For example, to measure the phase currents of the stator, the current sensor may include a set of shunt resistors (or other components having a known resistance) provided on the current paths of each of the motor phase windings. The current sensor 356 may be configured to measure the voltages across each of the shunt resistors from which the control logic 230 may calculate the current passing through corresponding phases of the motor using the known shunt resistances (i.e. from the simple relationship I=V/R). In some examples, the current sensor 356 may calculate the phase currents so as to provide the phase currents to the control logic 230 (rather than providing the voltage across each shunt resistor for the control logic to calculate the corresponding phase currents). Various other current measurement techniques are known in the art which may be used.

Note that only two of the phase currents (e.g. IU and IV) need to be measured since the third phase current (e.g. IW) may be calculated using Kirchhoff's current law, IU+IV+IW=0. It can however be advantageous to measure all three phase currents and rely on Kirchhoff's current law as means of redundant current measurement to ensure against circuit component failure.

A power source 358 is provided to power the motor 204 and its control apparatus 350. The power source may be a battery—e.g. a replaceable battery pack for a portable rammer. In order to drive the motor, the control logic is configured to control a power switch circuit 226 which provides voltage and current from the power source 358 to the motor 204 under the control of the control logic 230.

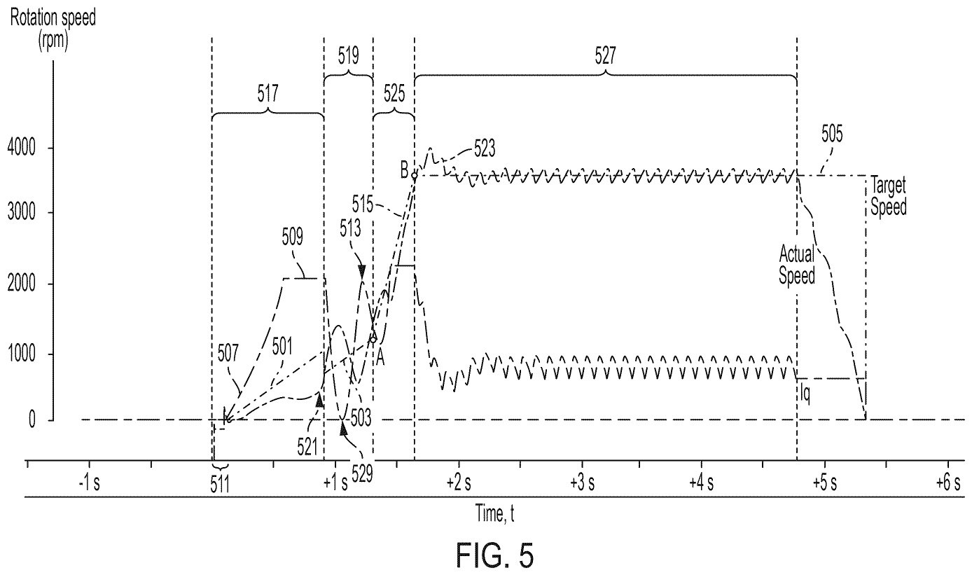

FIG. 5 illustrates the operation of an algorithm performed by the control logic 230 for improved startup control of a power tool driving a reciprocating or oscillating load, such as a rammer as discussed herein by way of example. In the figure, the operation of the algorithm is shown for a motor controlled according to an Field-Oriented Control (FOC) control mechanism, but in general the commutation control mechanism performed by the control logic 230 may be any suitable mechanism—for example, trapezoidal 6-step control or a V/Hz (also termed direct drive or V/F law) control scheme.

In FIG. 5, line 523 is a plot of the motor speed and line 507 is a corresponding plot of a drive current through the motor. In the present example, the motor 204 is a Brushless DC Electric (BLDC) motor and the drive current 507 is a current I_{q}, the quadrature component of the stator currents in a rotating reference frame that is synchronous with the rotor flux (as is explained below in further detail). The current I_{q} is proportional to the torque produced by the motor and is not measured directly by the current sensor 356 but can be calculated by the control logic 230 from the phase currents measured by the current sensor 356.

In general the drive current may be any suitable current or a combination of one or more currents provided to or measured at the motor. For the present algorithm it is advantageous if the drive current is a current which is representative of the torque produced by the motor. In some examples, the drive current may be a combination of one or more of the set of phase currents (e.g. an envelope describing a variation in the amplitude of a combination of one or more phase currents) applied to the stator windings (or rotor windings in the case of a motor having rotor windings) in any suitable reference frame. For example, the drive current may be an envelope (e.g. a curve or function derived from the phase currents) describing the amplitude of the phase currents over time.

The drive current may be determined in any suitable manner. For example, the quadrature current I_{q} may be determined by measuring the phase currents through the stator windings of the motor and transforming those currents into the quadrature current I_{q} through the application of the Clarke and Park transformations, as is described in further detail below.

In an initial phase 517, it may be necessary to perform 511 Initial Position Detection (IPD) of the rotor of the motor (e.g. step 702 of the algorithm in FIG. 7)—for example, in the case that the motor is sensor-less. Sensor-less motors may not include a rotor position sensor (e.g. position sensor 360) to indicate the orientation of the rotor to the motor control unit adapted to perform commutation of the motor. An example of Initial Position Detection (IPD) performed according to the FOC control mechanism is described in more detail below. It will be appreciated that in FIG. 5, the inferred motor speed 523 in the IPD phase 511 is observed to oscillate wildly while the motor control logic establishes the true position of the rotor (i.e. the plot of motor speed in this phase is not representative of the actual speed of the motor).

Once the position of the rotor has been established and drive currents may be applied to the motor, an initial target ramp 501 for the motor speed may be set for the motor control logic 230 to attempt to achieve according to the control scheme it implements (e.g. FOC control). In response, the control logic modulates the current 509 so as to attempt to achieve the target speed ramp 501. A peak in the current I_{q} in the initial phase 517 can be observed at 509. Further rotor alignment steps and/or improvements to the accuracy of the rotor position determined by the control logic may be performed in the initial phase. For example, High Frequency Injection (HFI) may be performed in the manner described below so as to accurately detect the rotor position at low speed.

If the motor includes a rotor position sensor 360, IPD and/or further rotor position detection techniques may not be required since the rotor position may be immediately known from the sensor output provided to the motor control unit.

A detection phase 519 starts at point 521 during which, in accordance with the teaching herein, the control logic is configured to identify a maximum 513 of the drive current 507. Under the FOC control scheme, the detection phase 519 may start when the motor reaches a predetermined speed (e.g. 900 rpm). This can be because techniques for determining rotor position suitable for use at low rotor speeds do not function well at higher speeds. For example, in the example shown in FIG. 5, the motor control unit switches to using a Sliding-Mode Observer (SMO) technique for determining the rotor position (angle). The SMO approach is described in further detail below.

In the detection phase 519, the control logic sets a first target speed ramp 704. In some examples, the motor control logic may follow a first target speed ramp having the same gradient as the initial target speed ramp in the initial phase 517. In other examples, the motor control logic may follow a different target speed ramp as in the initial phase 517. In some examples, the initial target ramp may be the first target ramp of the detection phase.

In FIG. 5, the motor control logic is configured to adopt a first target speed ramp in the detection phase which has the same slope but which has been shifted so that the target speed ramp matches the actual rotor speed as measured at the start of the detection phase. This improves the performance of the control scheme since it corrects for a deviation of the rotor speed from the target speed ramp during the initial phase. In some examples, the control logic may be configured to adopt a target speed ramp during the detection phase which has a different slope to the initial phase.

Suitable slopes for the target speed ramp during the detection and/or initial phases may be determined empirically so as to optimise performance of the startup control algorithm. The predetermined speed at which the control logic switches from using a lower speed rotor position algorithm (e.g. HFI) to a higher speed rotor position algorithm (e.g. SMO) may be determined empirically—e.g. based on the relative performance of the low and higher speed rotor position algorithms over the range of speeds over which the motor is intended to operate.

The control logic is configured to monitor 706 a drive parameter—in the present example, a drive current. The drive parameter is preferably indicative of an output power or torque provided by the motor. On detecting 708 a peak in the drive current 507, the control logic 230 is configured to switch to an acceleration phase 525 in which the control logic sets 710 a second target speed ramp 515 having a gradient which is steeper than the gradient of the target speed ramp 503 in the detection phase. The gradient of the target speed ramp in the acceleration phase may be at least 2, 5, 6, 7, 8, 9, 10, 11, 12, 15 times greater than the gradient of the target speed ramp in the detection phase.

It can be seen from FIG. 5 that in the acceleration phase 525 the actual motor speed 523 closely tracks the target speed ramp 515. The endpoints of the target speed ramp 515 are marked as A and B. This is because, as the inventors have recognised, once the drive current has peaked (e.g. on the downstroke of the compacting foot of the rammer when the upper mass assembly 260 of the rammer is being forced upwards against gravity), the reciprocating mechanism 200 is best adapted to absorb energy from its drive motor (e.g. on the upstroke of the compacting foot of the rammer when the weight of the upper mass assembly 260 of the rammer is acting cooperatively with the action of the motor). In fact, the peak current 513 is generally indicative that the rammer housing has reached its maximal upper position for the first time during the start up of the rammer. This is an optimal time to further accelerate motor speed because gravity can help with moving the rammer housing downwards (with gravity) towards its lower position. This approach enables the rammer to very quickly attain its steady state phase 527 in which the reciprocating mechanism of the rammer operates at its steady state speed 505 (the rotor speed plotted in FIG. 5 oscillates about the steady state speed 505 due to the action of the spring assembly of the rammer, which stores and releases energy through the reciprocating cycle).

The control logic 230 may be configured to end the acceleration phase and replace the second target speed ramp 515 by setting 712 the target speed to a predetermined steady state speed 505 (e.g. 3600 rpm) when the rotor speed 523 of the motor reaches the steady state speed 505. In some examples, so as to avoid the rammer overshooting the steady state speed, the control logic may be configured to switch from acceleration phase 525 to steady state phase 527 shortly prior to the steady state speed being attained. The rotational speed of the motor may be determined in any suitable manner, e.g. by (as is known in the art) monitoring the phase currents, using the back EMF of the motor, or through the use of one or more sensors provided in the motor.

In some examples, the steady state speed is variable. For example, the steady state speed may be selected by a user from a plurality of speeds appropriate to the power tool, e.g. rammer. For example, a suitable control switch may be provided at a rammer to enable a user to select between a low steady state speed of 3200 rpm and a high steady-state speed of 3600 rpm.

In some examples, one or more of the target speed ramps (e.g. 501, 503, 505) may be expressed as a ramp gradient: e.g. a rate of change in target speed over time. The target ramp may be linear or non-linear, with each such curve being defined by a number of parameters appropriate to a function describing the ramp (e.g. a linear ramp may be expressed by at least one coefficient parameter, a quadratic ramp may be expressed by at least two coefficient parameters, etc.). In some examples, one or more of the target speed ramps (e.g. 501, 503, 505) may be expressed as a target speed such that the ramp (i.e. the variation in target speed over time) may be inferred from the target speed and the starting speed. It is noted that the target speed or target speed ramp does not depend on the current rotational speed of the motor. In some examples, the second gradient at all points of the second target speed ramp is arranged to be greater than the first gradient at all points of the first target speed ramp.

It will be appreciated from a comparison of FIGS. 4A and 4B and 5 that the startup control algorithm taught herein substantially lowers the total power consumption of startup: in FIGS. 4A and 4B, the motor spends substantially longer at its maximum current. The startup phase (e.g. phases 517, 519 and 525 in FIG. 5) is also substantially shorter for the control algorithm taught herein, with the rammer achieving its steady state speed over twice as quickly than it does using a conventional linear ramp startup control as illustrated in FIGS. 4A and 4B. Furthermore, it can be appreciated from the plots of rotor speed in FIGS. 4 and 5 that the behaviour of a rammer configured to use a startup control algorithm as taught herein is substantially smoother and less erratic than a rammer using a conventional algorithm as illustrated in FIGS. 4A and 4B.

In some examples, additionally or alternatively to monitoring a drive current, the control logic 230 may be configured to monitor one or more of electrical power input, mechanical power output, mechanical torque, and phase current envelope in the detection phase 519. Such parameters may be monitored through the use of suitable sensors provided at the power tool. For example, mechanical power and/or torque may be measured by appropriate sensors (e.g. a rotational torque sensor comprising a strain gauge) on an output shaft of the electrical motor; and electrical power input may be measured by providing appropriate circuitry (e.g. to calculate electrical power based on the phase currents provided to the motor by the control logic). A phase current envelope may be determined by the control logic in any suitable manner—for example, by applying an envelope function to the oscillating phase currents so as to establish a curve describing a variation in the amplitude of a combination of the phase currents.

The control logic may be configured to detect a maximum (i.e. a peak) in one or more of a drive current (e.g. as described above), electrical power input, mechanical power output, mechanical torque, and phase current envelope (e.g. a curve describing an envelope function calculated for the phase currents). The maximum in any such parameter may be used to trigger the control logic switching from its detection phase to the acceleration phase.

In examples in which the control logic monitors a drive current in order to identify a maximum current during the detection phase, any suitable technique may be used to determine that current. For example, a current measurement approach is described below which can be used to measure the phase currents provided to the motor. Once the phase currents are known, currents may be calculated in other reference frames. For example, current I_{q} which is the quadrature component of the stator currents in a rotating reference frame that is synchronous with the rotor flux, and current I_{d} which is the in-phase component of the stator currents in a rotating reference frame that is synchronous with the rotor flux, may be calculated from the phase currents (see below for details of the calculation). As has been mentioned above, it is advantageous to use the current I_{q} because it is proportional to the torque of the motor and so provides an accurate measure of the point at which the useful drive current provided to the motor peaks—and so the point at which the control logic switches to the acceleration phase in the manner described herein.

In examples in which the control logic is configured to, in the detection phase, detect a maximum of the quadrature current I_{q}, it is further advantageous for the control logic to act so as to minimise the in-phase current I_{d} (e.g. for the control logic to attempt to maintain I_{d}=0). This minimises the reluctance torque and maximises the torque due to the Lorentz force due to the quadrature current I_{q}.

The control logic may be configured to detect a maximum (or minimum) in the monitored parameter (e.g. quadrature current I_{q}) in any suitable manner. For example, the control logic may determine the gradient (i.e. first derivative) of the monitored parameter with respect to time and identify a potential maximum or minimum when that gradient is zero. As will be well understood, a maximum or minimum may be established by checking values either side of the point at which the gradient is zero so as to identify whether the monitored parameter has peaked (the parameter values either side are smaller than the parameter value at the zero gradient point) or has found a minimum value (the parameter values either side are larger than the parameter value at the zero gradient point).

It can be seen from FIG. 5, however, that the current I_{q} exhibits many local maxima and minima due to oscillations of that parameter as it increases to its global maximum at 513. This behaviour will be shared in examples which use other monitored parameters (e.g. torque, electrical power, etc.). In order to avoid detecting the local maxima and minima, it is advantageous if the control logic is configured to filter the monitored parameter signal (e.g. current I_{q}) so as to remove, suppress or otherwise disregard the local oscillations in the signal. Any suitable filtering method may be used to generate a filtered signal in which detection of the global maximum can be performed without suffering from erroneous detection of local maxima and minima. The filtering may be performed at one or more filters 352 of the control logic 230.

In some examples, the control logic may be configured to apply a low pass filter to the monitored parameter so as to generate a filtered signal which does not include, or has suppressed, frequencies above a predetermined threshold. For example, higher frequencies may be filtered from the monitored signal using a Fourier transform, an electronic filter (e.g. an RC filter), an infinite impulse response filter, a simple averaging (e.g. a running average) over a time period selected to reject high frequency variations in the signal, etc. A suitable predetermined threshold may be, for example, 100 Hz—e.g. a low pass filter with a cut-off frequency of 100 Hz may be used to filter out variations in the monitored parameter having a frequency higher than 100 Hz. In some examples, the predetermined threshold may be selected to be at least twice, at least 5 times, at least 8 times, or at least 10 times the steady state frequency of the reciprocating or oscillating tool (e.g. the rammer). It is advantageous for the predetermined threshold frequency to be as high as possible whilst damping or removing variations in the monitored parameter that may lead to the system identifying a maximum/minimum in the high frequency variations as a maximum/minimum in response to which the control logic is to change the motor ramp speed in the manner described herein.

In some examples, the local oscillations at a higher frequency may be filtered out by sampling the monitored parameter at a frequency which does not capture the expected frequency of those oscillations. For example, the sampling may be performed at a frequency below the Nyquist limit of the expected frequency of the local oscillations—e.g. if the expected frequency of the oscillations is 100 Hz then samples might be acquired every 20 ms (corresponding to a frequency of 50 Hz). The maximum/minimum may be detected by monitoring the linear gradient between sample points: a switch from positive to negative gradient indicates a maximum; and a switch from negative to positive gradient indicates a minimum. In some examples, the sampling of the monitored parameter may be at a higher frequency than necessary to filter out the higher frequency local oscillations but the control logic may be configured to use only some of the sample points so as to effectively lower the sampling frequency. For example, if the monitored parameter is sampled at 200 Hz, every fourth sample point may be used by the control logic (e.g. by monitoring the linear gradient between sample points so as to identify maxima/minima as described above) so as to give an effective frequency of 50 Hz.

The filtering may be performed on an analogue or digital signal, as appropriate to the implementation. In some examples, a filter may be used to suppress or remove frequencies above twice the steady state frequency of the motor in use when driving its mechanical load in the reciprocating or oscillating cycle.

It is noted that use of a filter to avoid the detection of local maxima and minima will typically result in a delay to identifying the global peak since the filter will require a portion of the signal (e.g. a set of samples) over a period of time longer than the frequency of oscillations to be rejected by the filter. For example, in FIG. 5, this can be observed from the length of time between the global peak 513 occurring and the point A at which the control logic switches to the acceleration phase in response to a maximum being identified in the filtered signal. In examples in which the tool is a rammer, point A might occur, for example, at 1100 Hz.

It is advantageous if the control logic is configured to, on detecting a maximum in the monitored parameter (e.g. quadrature current I_{q}), immediately switch from the detection phase to the acceleration phase. This helps to minimise the total length of the startup phase (i.e. to reaching the steady state phase 527) and minimise energy expenditure during startup. It will be appreciated that the point at which the detection phase switches to the acceleration phase (point A in FIG. 5) will generally not occur at the same point in time as the maximum 513 of the monitored parameter. This is because, in order to establish that the monitored parameter has reached its maximum, it is typically necessary to observe the monitored parameter reach its maximum and drop (and, as is noted above, it is generally necessary to average the monitored parameter over a period of time to avoid detecting minor local maxima and minima). In some examples, the control logic may be configured to delay switching to the acceleration phase by a predefined length of time (e.g. 100 microseconds, 1 ms, 10 ms, 15 ms, 20 ms, 25 ms, or 100 ms).

In alternative examples, the control logic may be alternatively configured to detect a minimum 529 in the drive parameter. On detecting the minimum in the drive parameter, the control logic is configured to switch from a first target speed ramp performed in the detection phase 519 to a second target speed ramp having a gradient which is less steep than the gradient of the first target speed ramp. This approach is not illustrated in FIG. 5 other than to indicate the position of the minimum 529 in the particular example shown in the figure. In this approach, the steeper first target speed ramp coincides with the period at the start of detection phase 519 when the drive current is decreasing (c.f. the decreasing current following the peak at 513 discussed above) indicating that gravity is assisting with moving the rammer housing downwards. At this point the motor speed can be efficiently accelerated.

A significant proportion of the acceleration of the motor can be achieved at the start of the detection phase 519. Once the minimum in the drive parameter (e.g. current) has been detected, the control logic switches to the less steep second target speed ramp so as to avoid overshoot and ensure that the steady state speed is efficiently attained.

It will be appreciated that, aside from the gradients of the first and second target ramps, any of the features described above in relation to examples in which the gradient of the second target ramp speed is steeper than the first target ramp speed shall apply to examples in which the gradient of the second target ramp speed is less steep than the first target ramp speed. In particular, it will be appreciated that any of the features described above made in relation to detecting a maximum in the drive parameter shall apply to detecting a minimum in the drive parameter in the alternative examples.

### Commutation Control Schemes

The startup control algorithms described herein may be used with any commutation control scheme for driving the motor. In some examples, control logic 230 controls commutation of the motor 16 using a vector control technique referred to as field-oriented control (FOC). FOC is a variable-frequency drive control algorithm that provides several advantages over conventional trapezoidal control or voltage-over-frequency (V/Hz) control schemes often used in power tools having brushless motors.

Trapezoidal 6-step commutation control is simple to implement and execute and is therefore a popular option. However, this control scheme can generate high torque ripple, particularly at low speed, which can lead to high vibration and motor noise.

Voltage-over-frequency (V/Hz) control, also known as sinusoidal control, may also be implemented in power tool motor control systems. V/Hz control is a scalar control scheme where a ratio of voltage and frequency is held constant as motor speed (i.e., Hz) changes. This scheme overcomes the torque-ripple issues seen in trapezoidal control by supplying smoothly-varying sinusoidal currents to the motor phases. However, in high-speed operations, where the frequency of motor rotation increases, it becomes more challenging to maintain the desired voltage and current using this scheme.

A V/Hz control scheme is typically performed in open loop with respect to current. V/Hz control effectively provides a given three-phase sinusoidal voltage pattern base on rotor position, where the voltage amplitude is controlled based on motor speed so as to maintain a constant V/Hz ratio. A Proportional Integral (PI) controller may be provided to reduce motor speed when the current exceeds a current limit, but current and torque is otherwise not well controlled.

FOC is different from sinusoidal control in that a current loop is provided using measured motor currents and without reference to the motor's rotation. FOC thus offers more precise torque and speed control over the complete range of motor operation. Particularly, FOC offers better efficiency for high speed operations as well as operating involving dynamic load changes than V/Hz control.

In FOC, the three phase currents of the stator are measured and converted to two orthogonal components that can be combined in a vector. The first component, known as direct current I_{d}, is the magnetic flux of the motor induced in the stator windings due to rotation of the rotor within the stator. This component runs parallel to the pole axis of the rotor and does not apply a rotational force on the rotor. The second component, known as quadrature current I_{q}, is proportional to the motor torque. This component runs perpendicular to the pole axis of the rotor and applies force generating rotational torque. These two components may be controlled independently by the control logic.

The I_{d} current is typically desired to be 0 to minimize the unwanted direct torque component contributing to current losses for a given motor operating point. The level of the I_{q} current may be varied to achieve the desired torque. Since the two orthogonal components are defined in the rotating reference frame of the motor, the control logic is able to control the currents irrespective of motor speed. By controlling these two currents, the motor torque and speed can be directly controlled.

### Field-Oriented Control (FOC)

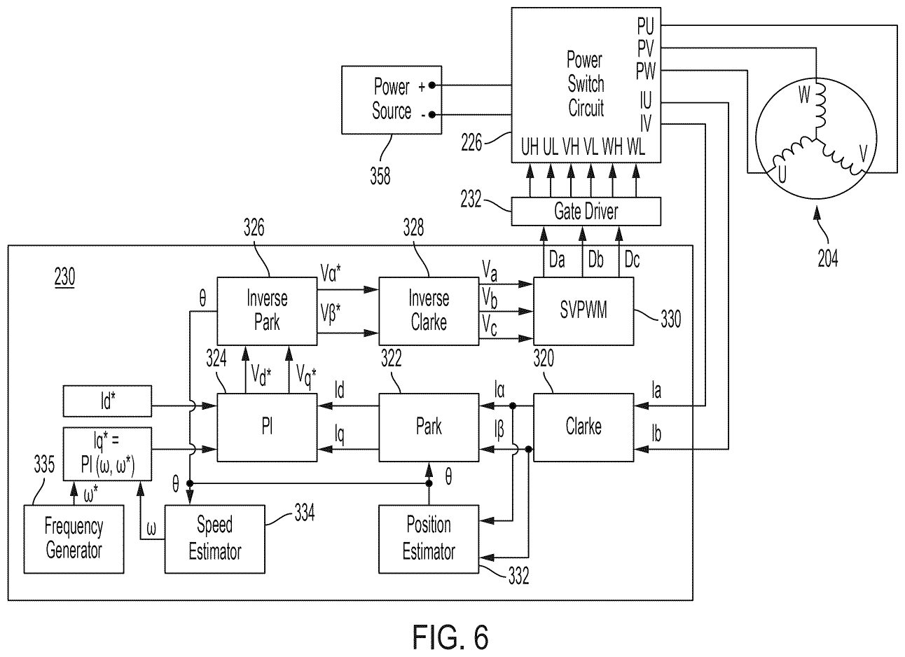

In some examples, the control logic is configured to perform commutation of BLDC motor 204 according to Field-Oriented Control (FOC). The use of FOC algorithms will now be described with reference to the block system diagram of FIG. 6 which shows an exemplary configuration of control logic 230. The control logic 230 is configured to calculate the angular position of the rotor by analysing phase current signals from the motor provided by current sensor 356. Control logic 230 may utilise different FOC algorithms (e.g. IPD, HFI, SMO) to perform position detection depending on the speed of the motor, as is described in more detail later in the present disclosure.

In the example shown in FIG. 6, the current sensor is provided at the power switch circuit 226 such that the power switch circuit provides two of the stator phase currents, IU and IV. The control logic 230 receives the two phase currents as currents Ia and Ib and may calculate the third phase current Ic using Kirchoff's current relation, Ia+Ib+Ic=0, where Ia, Ib, and Ic are the three phase currents. The control logic 230 includes a Clarke transformation unit 320 that converts the three phase currents, which are typically sinusoidal, into a 2-axis coordinate system in the fixed frame of reference. The Clarke transformation unit 320 produces two signals Iα and Iβ, which are two (typically sinusoidal) waveforms that are 90 degrees apart in phase.

Components of the 2-axis coordinate system of the stator currents are time varying and difficult to process using traditional Proportional Integral (PI) processes. Thus, it can be advantageous for the control logic 230 to include a Park transformation unit 322 that converts the two-axis system from a fixed reference to a rotating reference frame that is synchronous with the rotor flux. Park transformation unit 322 uses a rotor position signal θ (e.g. from a position sensor 360 or derived in the manner described below) to convert Iα and Iβ to DC waveforms Id and Iq, where Id and Iq are the in-phase and quadrature components of the stator currents, respectively. As described above, the Id current is aligned with the rotor flux, whereas the Iq current is orthogonal to the rotor flux and is therefore responsible for torque generation.

Control logic 230 may include a position estimator 332 that calculates (estimates) the rotor orientation θ using the motor current signals Iα and Iβ. This can be useful if the motor does not include a position sensor 360. The present disclosure describes various methods used to estimate rotor position according to the FOC scheme. As will be described later in detail, these methods can vary depending on whether the motor is at start-up, low-speed operation, or high-speed operation.

The control logic 230 may include a speed estimator 334 that calculates (estimates) motor speed w based on the rate of rotor position change in the rotor positional signal θ.

The control logic 230 may include a PI (Proportional-Integral) loop controller 324 that compares the corresponding axis vectors with reference currents Id* and Iq* (e.g. set by the control logic according to the target motor speed) and determines Id error correction signals to generate DC drive voltage signals Vd* and Vq* accordingly. The Id* reference controls the rotor magnetization flux. The Iq* reference controls the torque output of the motor. Since Iq generates motor torque and Id does not, it can be advantageous to set the Id* reference to 0 and Iq* to a target value. The obtained DC drive voltage signal Vq* corresponds to the amount of voltage correction that is needed to produce a current Iq* so as to generate the torque required to drive the motor at the desired (target) speed (e.g. as set in accordance with the startup algorithm described above).

A frequency generator 335 may be provided to generate a target speed reference signal ω* as a function of the target speed of the motor. In some examples, Iq* is calculated as a PI function of the calculated motor speed ω and the target speed reference signal ω*.

Since the DC drive voltage signals Vd* and Vq* are defined in a rotating reference frame, the control logic 230 may include an inverse Park transformation unit 326 that converts the DC drive voltage signals Vd* and Vq* signals back to fixed reference frame drive voltages Vα* and Vβ*. Control logic 230 may also include an inverse Clarke transformation unit 328 that converts the fixed reference frame drive voltage signals Vα* and Vβ* from the fixed 2-axis coordinate system back into the 3-axis coordinate system defined for the three motor phase voltage signals Va, Vb, and Vc.

In some examples, the control logic 230 may include a Space-Vector Pulse-Width Modulation (SVPWM) unit 330, which receives the three phase voltage signals Va, Vb, and Vc and generates drive signals Da, Db and Dc for controlling the switching operation of the power switch circuit 226 accordingly. SVPWM unit 330 is configured to control the duty cycles of the drive signals Da, Db and Dc in such a way that the power switch circuit 226 outputs a substantially sinusoidal phase voltage waveform on each of the phase lines Pu, Pv, and Pw of the motor 204. These sinusoidal phase voltage waveforms are 120 degrees apart and correspond to the three motor phase voltage signals Va, Vb, and Vc.

In some examples, the drive signals Da, Db and Dc may be received at a gate driver 232 comprising circuitry configured to generate output drive voltage signals UH, VH, WH, UL, VL, and WL at voltage levels suitable to drive the gates of semiconductor switches (e.g. field-effect transistors or FETs) within the power switch circuit 226. By controlling a PWM switching operation of semiconductor switches at the power switch circuit 226 by means of the drive signals, control logic 230 can therefore control the direction and speed at which the motor windings are sequentially energized, thus electronically controlling the motor commutation.

The details of SVPWM modulation is beyond the scope of this disclosure and will be known by persons skilled in the art of motor control.

### Alternative Startup Algorithm

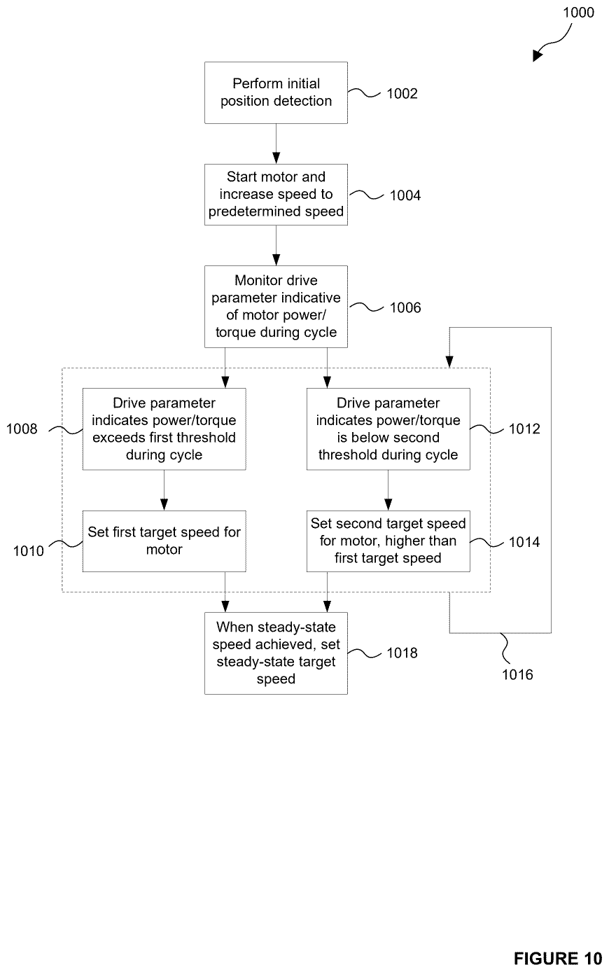

An alternative approach to performing startup control for an electric motor driving a reciprocating or oscillating load will now be described. The described methods may be used in the startup of a rammer as described above with reference to FIGS. 1 and 2. The alternative approach may be implemented at the motor control apparatus 350 described above with reference to FIG. 3 for controlling motor 204 of the drive mechanism 224 shown in FIG. 3. The motor control apparatus 350 may be configured according to any of the examples described above. For example, the control logic 230 may be configured to perform any suitable commutation control scheme, such as trapezoidal 6-step control, a V/Hz (also termed direct drive or V/F law) control scheme, or a Field-Oriented Control (FOC) scheme. An exemplary algorithm 1000 for performing motor startup according to the alternative approach is shown in FIG. 10.

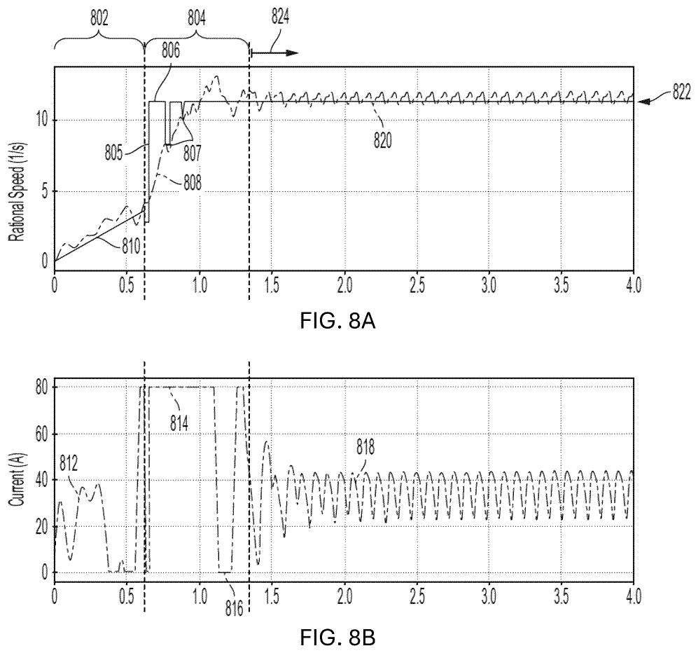

FIGS. 8A and 8B illustrate the operation of an algorithm performed by the control logic 230 for improved startup control of a power tool driving a reciprocating or oscillating load, such as a rammer as discussed herein by way of example. In the figure, the operation of the algorithm is shown for a motor controlled according to a Field-Oriented Control (FOC) control mechanism, but in general the commutation control mechanism performed by the control logic 230 may be any suitable mechanism—for example, trapezoidal 6-step control or a V/Hz (also termed direct drive or V/F law) control scheme.

In FIGS. 8A and 8B, line 808 is a plot of the rotational speed of the motor and line 812 is a corresponding plot of a drive current through the motor. In the present example, the motor 204 is a Brushless DC Electric (BLDC) motor and the drive current 507 is a current I_{q}, the quadrature component of the stator currents in a rotating reference frame that is synchronous with the rotor flux (as is explained below in further detail). The current I_{q} is proportional to the torque produced by the motor and is not measured directly by the current sensor 356 of the motor control apparatus 350 but can be calculated by the control logic 230 from the phase currents measured by the current sensor 356.

In general the drive current may be any suitable current but for the present algorithm it is advantageous if the drive current is a current which is representative of the torque produced by the motor. In some examples, the drive current may be a combination of one or more of the set of phase currents applied to the stator windings (or rotor windings in the case of a motor having rotor windings) in any suitable reference frame. For example, the drive current may be an envelope describing the amplitude of the phase currents.

The drive current may be determined in any suitable manner. For example, the quadrature current I_{q} may be determined by measuring the phase currents through the stators of the motor and transforming those currents into the quadrature current I_{q} through the application of the Clarke and Park transformations, as is described in further detail below.

FIG. 8A shows a target rotational speed 805 in accordance with the present startup approach. In an initial phase 802, a target speed ramp 810 is adopted by the control logic 230. In the initial phase, initial position detection (IPD) may be performed 1002 in the manner described herein order to establish the starting position of the motor and the motor speed increased 1004 according to the target speed ramp until a predetermined speed is reached. The target speed in the initial phase may vary in any suitable manner—for example, the target ramp may be linear or non-linear. It is generally necessary to limit the target speed during the first few commutations of the motor so as to avoid excessive drive current through the motor. For example, if the control logic were to immediately adopt the steady state speed 822 of the power tool (e.g. rammer) as the target speed, the current through the motor would immediately reach a maximum as the control logic attempts to achieve that target speed.

In the present example, the control logic may be configured to perform the initial phase until the motor reaches a predefined rotational speed (e.g. 250 rpm). In other examples, the control logic may be configured to perform the initial phase for a predetermined length of time. At the end of the initial phase, the control logic is configured to switch to a target speed modulation phase 804. In the target speed modulation phase 804, the control logic is configured to monitor a drive parameter 1006 and set the target motor speed according to that monitored parameter. The drive parameter is indicative of the power/torque generated by the motor over the reciprocating/oscillating cycle driven by the motor. When the level of power consumption is low 1012 during the cycle, the target motor speed is set 1014 to a high target speed; when the level of power consumption is high 1008 during the cycle, the target motor speed is set 1010 to a low target speed. This is repeated over a plurality of cycles 1016 until the steady state speed 822 is achieved by the drive mechanism and the steady state phase 824 is entered at which point the control logic may set 1018 the target speed of the motor to the steady-state speed.

In the example shown in FIGS. 8A and 8B which corresponds to the motor of the rammer shown in FIGS. 1 and 2, the control logic 230 is configured to monitor the rotation angle of the motor as an indication of the power consumption of the motor. When the rotation angle of the motor indicates that the upper mass assembly of the rammer is moving downwards under the assistance of gravity, the target speed is set to a high value 806—in this example, the high target speed is the steady state speed 822. And when the rotation angle of the motor indicates that the upper mass assembly of the rammer is moving upwards against gravity, the target speed is set to a low value 807—in this example, the low target speed is set equal to the actual measured speed of the motor (since setting the target speed lower than the actual motor speed would result in the control logic acting to decelerate the motor). However, it is advantageous if the low target speed is capped at (i.e. does not exceed) the steady state speed 822 so as to avoid the target speed being set above the steady state speed when the actual measured speed of the motor happens to exceed the steady state speed.

Note that because the low target speed is set to the (capped) actual motor speed, there are no occurrences of drops in the target speed below the target steady state speed in the second half of the target speed modulation phase 804 when the actual measured motor speed exceeds the steady state speed at the points the rotation angle of the motor indicates a low target speed.

A plot of the consequent drive current 812 through the initial, power modulation and steady-state phases is shown in FIG. 8B. It can be observed that a high (maximal) drive current 814 is provided to the motor under the control of the control logic for a significant proportion of the target speed modulation phase. Note that the drive current stays high even when the target speed is set low because the periods of low target speed coincide with rammer entering a phase when its upper mass assembly is moving upwards against gravity and therefore the current demand is high in order to attempt to maintain the motor speed achieved at the bottom of the stroke when the downward movement of the upper mass assembly was assisted by gravity. The drive current then drops to a low (minimal) drive current 816 when the rotation speed of the motor exceeds the target steady state speed.

Once the steady state speed 822 has been achieved and the control logic switches from the target speed modulation phase 804 to the steady state phase 824, the motor speed 820 oscillates about the steady state speed due to the action of the spring assembly of the reciprocating mechanism 200 and the action of gravity on the upper mass assembly 260 of the rammer. It will be observed from FIG. 8B that the current demand 818 of the motor in the steady state similarly oscillates about an average current required to maintain the steady state speed.

The monitored parameter may be one or more of: a current provided to the motor (a drive current)—for example, quadrature current I_{q} or an envelope representing the amplitude of the phase currents; a mechanical torque output of the motor; an output mechanical power of the motor; an input electrical power to the motor; an acceleration of the reciprocating/oscillating tool part (e.g. the acceleration of the upper or lower mass assembly of the rammer, as may be measured by an accelerometer mounted at the respective assembly); and an orientation/rotation angle of the motor (since the orientation of the motor is indicative of the power consumption of the motor).

As has been discussed in relation to FIGS. 1 and 2, when the compacting foot 112 is being extended (a down-stroke) the upper mass assembly 260 is pushed upwards which requires a higher level of power input (current) to the motor, and when the compacting foot 112 is being retracted (an up-stroke) the upper mass assembly 260 can fall downwards under the assistance of gravity which therefore requires a lower level of power input (current) to the motor.

The alternative startup approach builds on the realisation by the inventors that the reciprocating/oscillating system can be most easily accelerated during phases of lower power consumption by the motor when (for a fixed target speed) a small mechanical torque is applied to the drive mechanism.

In some examples, the high target speed may be a function of the current measured speed of the motor. For example, the high target speed may be a fixed amount higher (e.g. 50, 75 or 100 rpm higher) than the measured speed, or a proportional amount higher (e.g. 5%, 10% or 20% higher or lower) than the measured speed. In this manner, the high target speed may be lower at lower motor speeds (i.e. towards the start of the target speed modulation phase) and a higher at higher motor speeds (i.e. towards the end of the target speed modulation phase). As discussed, it is advantageous to cap the high target speed at the steady state speed—in this sense, the high target speed may be a function of the steady state speed.

In some examples, the low target speed may be a function of the current measured speed of the motor (e.g. may be dynamically determined based on the motor speed). For example, as discussed, the low target speed may be set equal to the current measured speed of the motor. In other examples, the low target speed may be a fixed amount higher (e.g. 10, 25 or 50 rpm higher) than the measured speed, or a proportional amount higher (e.g. 2%, 5% or 10% higher) than the measured speed. In such approaches, the low target speed may be lower at lower motor speeds (i.e. towards the start of the target speed modulation phase) and a higher at higher motor speeds (i.e. towards the end of the target speed modulation phase). It is important to cap the low target speed at the steady state speed—in this sense, the low target speed may be a function of the steady state speed.

In examples in which the control logic is adapted to perform startup control based on rotation angle, the control logic may be configured to set the target speed to its high target value while the rotation angle indicates that the compacting foot is retracting (and the upper mass assembly moving downwards under gravity) and to set the target speed to its low target value while the rotation angle indicates that the compacting foot is extending (and the upper mass assembly moving upwards against gravity).

In examples in which the control logic is adapted to perform startup control based on current, torque, acceleration, or power input/output, the control logic may be configured to set the target speed to its high target value while the current, torque, acceleration, or power input/output indicates that the power consumption is low (e.g. the current, torque, acceleration, or power input/output is below a first threshold) and to set the target speed to its low target value while the current, torque, acceleration, or power input/output indicates that the power consumption is high (e.g. the current, torque, acceleration, or power input/output is above a second threshold). In some examples, the first and second thresholds may be the same. Typically, it is advantageous for the first and second thresholds to differ, with the second threshold being higher than the first threshold, so as to avoid rapid changes back and forth between the high and low target speeds due to oscillations of the monitored parameter about a single threshold. Suitable first and second threshold values for each monitored parameter may be determined empirically.

The advantages of the startup control approach described above with respect to FIGS. 8A and 8B are illustrated in FIGS. 9A and 9B. FIG. 9A compares the rotational speed 403 of a rammer motor during startup when its control logic follows a simple target speed ramp 401 against the rotational speed 808 of a rammer motor during startup when its control logic modulates the target speed ramp 805 in accordance with the principles described herein.

It will be observed that the startup phase of the rammer is substantially shorter when using the approach taught herein: the steady state phase is achieved earlier by the time period 903 indicated in FIGS. 9A and 9B. Furthermore, since the startup phase is shorter and the drive current during startup in periods of high power consumption is lower, the total energy consumption during startup is substantially lower than with the conventional simple ramped target speed approach.

FIG. 9B compares the displacement 901 of the primary housing 102 of the rammer (and therefore its upper mass assembly 260) when using a conventional ramped target speed approach, against the displacement 902 of the primary housing 102 of the rammer (and therefore its upper mass assembly 260) when using the modulated target speed approach taught herein. It will be apparent from the figure that the amplitude of the housing displacement is substantially less when using the modulated target speed approach, and the duration is shorter of the larger displacements observed in the startup phase of the rammer. In other words, use of the modulated target speed approach taught herein substantially improves the erratic and aggressive behaviour conventionally seen in rammers during startup. The subjective user experience is therefore improved, with smoother and less aggressive rammer behaviour during a shorter startup phase.

### Rotor Position Estimation Using FOC

The use of a Field-Oriented Control (FOC) scheme to perform rotor position estimation will now be described in further detail. The use of FOC schemes is particularly useful for the control of sensorless motors which do not include a position sensor.

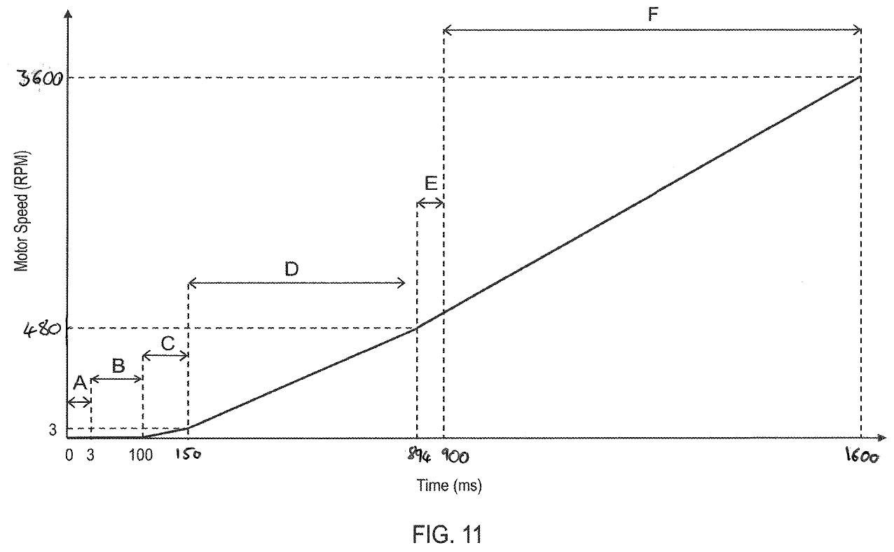

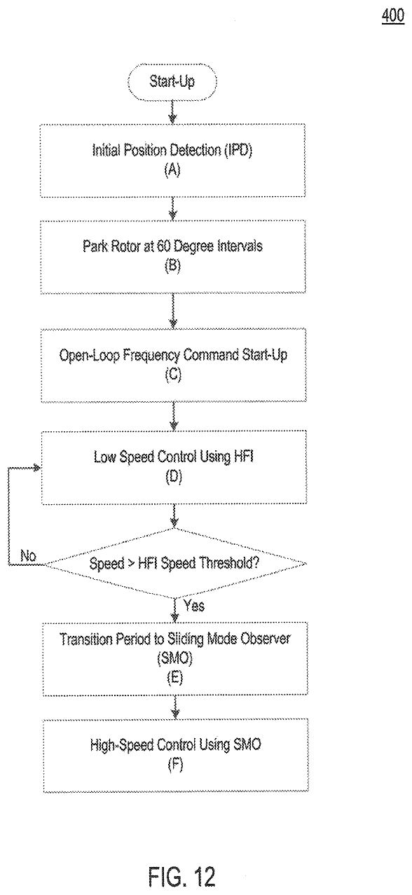

FIG. 11 depicts a speed-time diagram depicting procedures implemented by control logic 230 to determine the rotor position (e.g. at position estimator 322 in FIG. 6) from start-up to full speed. In this example, the motor full speed is 3600 rpm, though it should be understood that this value is by way of example only. In the case of a rammer, the full speed might be between 3000 and 4000 rpm. FIG. 12 depicts a flow diagram for a process 400 corresponding to FIG. 11.

Conventional sensorless FOC implementations may be found in applications such as washing machines and other home appliances that operate at substantially constant speed and constant torque. In such implementations, after an initial detection of the rotor position, FOC execution may be handle with relative ease without significant changes to the rotor speed or torque output. In power tool applications, however, the rotor speed is subject to rapid change—for example during startup of power tools for driving a reciprocating or oscillating load, such as a rammer, or based on a change in torque as the power tool engages a work piece. FOC provides a technique for reliable detection of the rotor position in a variable-speed and/or variable-torque environment suitable for a power tool.

Referring to FIGS. 11 and 12, at motor start-up, i.e., after the power tool is initially powered up, control logic 230 executes a process herein referred to as Initial Position Detection (IPD) to estimate the rotor position at step A. IPD allows control logic 230 to detect the initial angular position of the rotor with approximately a 30-degree accuracy. In other words, control logic 230 identifies the motor sector within which the rotor angle is located. In an embodiment, this step is completed within approximately 1-10 ms, in this example 3 ms.

After the rotor sector position is estimated in IPD, in an embodiment, control logic 230 proceeds to park the rotor at discrete positions at step B. The reasons for and details of this step are described later in detail. In an embodiment, the parking process entails forcing the motor to rotor to the end of the detected sector, i.e., at discrete positions that are 60 degrees apart. In an embodiment, this step is performed for approximately 50-300 ms, in this example approximately 100 ms.

After parking, control logic 230 issues an open-loop frequency command for motor start-up at step C. In this step, while the parking force is still being applied to the motor, control logic 230 begins to generate and apply High-Frequency Injection (HFI) voltage signals to the motor. This allows control logic 230 to detect the rotor position more accurately via an HFI position estimator described later in detail. Also, this step allows control logic 230 to remove the parking current and begin commutating the motor using the detected rotor position to kick-start the motor. In an embodiment, this step is performed in approximately 10-200 ms, in this example approximately 50 ms.

Control logic 230 fully transitions to closed-loop control using HFI for a low-speed motor operation at step D. As discussed later in detail, HFI entails applying high frequency voltage pulses to the drive voltage signals and reading the corresponding current to detect the rotor position. Control logic 230 continues this process until a speed threshold (herein referred to as the HFI speed threshold) is reached. HFI speed threshold may correspond to the motor speed below which the motor does not generate sufficiently dependable back-EMF phase voltage that can be detected and reliably used by control logic 230 to calculate the motor position. In some examples, the HFI threshold may be a predefined threshold—e.g. 900 rpm for a rammer.

Although low-speed operation of steps C and D is described in this disclosure using HFI by way of example, it should be understood that other suitable sensorless start-up and low speed motor control methods may be employed in place of HFI. In one example, motor may be operated using an open-loop kickstart control scheme until the HFI speed threshold is reached. This scheme entails using a preset commutation sequence beginning at the IPD/Parking position and ramping up the motor speed using the preset commutation sequence at open loop, without reference to the rotor position. Alternatively, a sector detection scheme as disclosed in U.S. patent application Ser. No. 16/853,140 filed Apr. 20, 2020, which is incorporated by reference in its entirety, may be employed in place of HFI. In this scheme, control logic 230 pauses motor drive control to inject voltage pulses in the present and subsequent sectors. Based on the corresponding current waveforms, control logic 230 detects when to commutate the subsequent sector.

At high speed, i.e., at speeds greater than the HFI speed threshold, control logic 230 transitions from HFI to a process referred to as Sliding Mode Observer (SMO) at step E. In an embodiment, the transition step may be completed in a few milliseconds. Once the transition period is complete, control logic 230 performs closed-loop motor control using SMO at step F at motor speeds above the HFI speed threshold up to the maximum motor speed. In an embodiment, SMO is process for estimating the motor back-EMF using the phase currents. HFI speed threshold referred to above may be set to a speed value below which SMO is unable to accurately detect the motor back-EMF using the phase currents, and therefore the HFI process is relied upon instead.

Although step F is described in this disclosure using SMO by way of example, it should be understood that other suitable rotor tracking methods may be employed in place of SMO. Examples of such methods include, but are not limited to, phase-locked loop (PLL) control for tracking the rotor position based on motor currents and applied motor voltages.

Each of the steps A-F is described in further detail below.

### Initial Position Detection

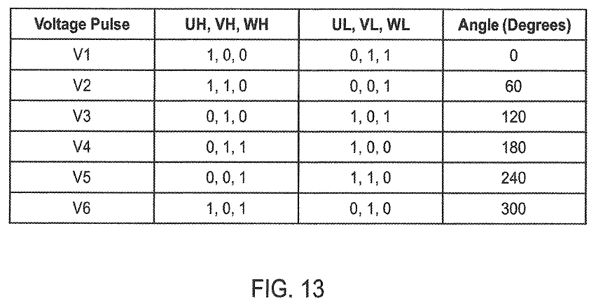

The process of Initial Position Detection (IPD) (Step A) is described herein with reference to FIGS. 13-15.

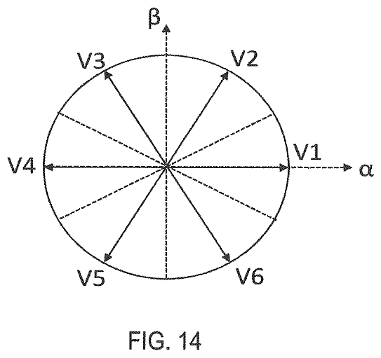

FIG. 13 depicts an exemplary excitation sequence table including high-side and low-side drive signals corresponding to rotor angles V1-V6 within a full rotation of the rotor, according to an embodiment. FIG. 14 depicts a diagram representing a full 360-degree orientation of the rotor angles from V1 through V6, according to an embodiment. In this embodiment, V1 through V6 correspond to 60-degree intervals of the rotor orientation beginning at 0 degrees.

IPD allows control logic 230 to detect the initial angular position of the rotor with approximately a 30-degree accuracy. In other words, control logic 230 identifies the motor sector within which the rotor angle is located. In IPD, control logic 230 sequentially injects a series of voltage pulses in accordance with the drive signals of FIG. 13 at rotor angles V1 through V6. Each voltage pulse has the same voltage and duration. In this embodiment, for each voltage pulse, two high-side FETs and a low-side FET, or one high-side FET and two low-side FETs, are simultaneously activated. For example, voltage V1 (corresponding to 0-degree rotor angle) is applied by activating UH, VL and WL signals of the power switch circuit 226, voltage V2 (corresponding to 60 degrees rotor angle) is applied by activating UH, VH and WL signals of the power switch circuit 226, etc.

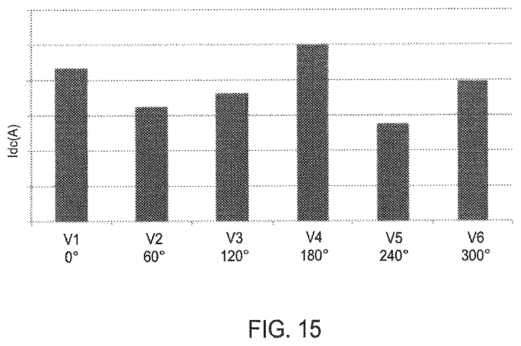

In an embodiment, after each voltage pulse, control logic 230 measures the corresponding motor current using the shunts as previously described. FIG. 15 depicts an exemplary diagram showing the measured current for each pulse.

The voltage pulse closest to the actual the position of the rotor generates the highest inductive current. Thus, control logic 230 identifies the rotor angle to be in close proximity to the angle associated with the highest-current voltage pulse. In this example, I_{V4} exhibits the largest current amplitude. Thus, it is determined that the actual rotor position is in the proximity of rotor angle V4. In an embodiment, where 6 voltage pulses are applied, control logic 230 identifies the rotor position as V4±30 degrees.

The IPD process described here is usually reliable for estimating the sector in which the rotor is located. It has been found, however, that in some instances, the detected current may be too close to distinctly identify the correct rotor position. For example, in FIG. 15, where the rotor position is close to V4 (180 degrees), the two largest current pulses are associated with V1 (0 degrees) and V4 (180 degrees).

In an embodiment, to solve this problem, control logic 230 ensures that the largest current pulse is greater in amplitude than the second-largest current pulse by at least a threshold. For example, in FIG. 15, if I_{V4}=20 A, I_{V1}=17 A, and the threshold=1 A, control logic 230 determines that the difference between the two current pulses exceeds the threshold and selects angle V4 as the correct proximate area of rotor position.

However, if threshold is not satisfied, control logic 230 may determine the correct angle by examining the neighbouring current pulses of the two peak current pulses. The current pulse whose neighbouring pulses are on average larger is the correct sector. For example, in FIG. 15, control logic 230 can determine whether the neighbouring rotor angles of V4 (i.e., V3 and V5) have larger average current pulses than the neighbouring rotor angles of V1 (i.e., V2 and V6). Since in this example (I_{V3}+I_{V5})>(I_{V2}+I_{V6}), control logic 230 determines rotor angle V4 to be the correct proximate area of rotor position, even if the I_{V1} and I_{V4} pulses were closer in magnitude.

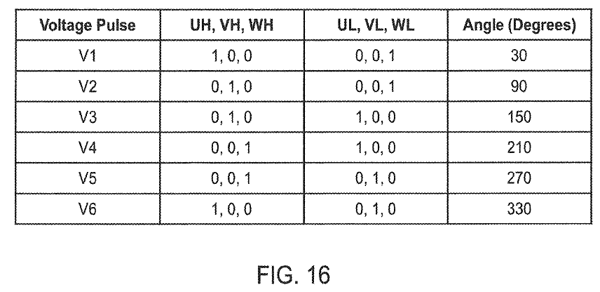

FIG. 16 depicts an alternative excitation sequence table including high-side and low-side drive signals corresponding to rotor angles V1-V6 within a full rotation of the rotation of the rotor, according to an embodiment. In this embodiment, rotor angles V1-V6 respectively correspond to a different range of angles from FIG. 13, in this example 30 to 330 degrees at 60-degree intervals, according to an embodiment. This arrangement allows for only one high-side FET and one low-side FET to be simultaneously activated for each voltage pulse. For example, voltage pulse V1 (corresponding to 30 degrees rotor angle) is applied by activating UH, and WL signals of the power switch circuit 226, voltage pulse V2 (corresponding to 90 degrees rotor angle) is applied by activating VH and WL signals of the power switch circuit 226, etc.

### Parking

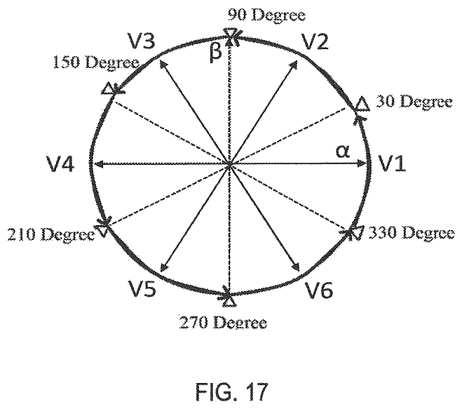

The parking process (stop B) is described herein with reference to FIGS. 16 and 17, according to an embodiment.

In an embodiment, the IPD process described above allows the control logic 230 to robustly identify the location of the rotor with a 60-degree resolution, i.e., within one of six sectors defining the full range of the angular orientation of the rotor. In an embodiment, to enable the control logic 230 to begin motor start-up at a more precise rotor angle than the 60-degree resolution provided by IDP, control logic 230 is configured to park the rotor at 60-degree intervals. In an embodiment, the rotor parking location is set to 30 degrees after respective angles V1 though V6. In an embodiment, for IPD execution according to FIGS. 13-15, the parking angles are determined according to FIG. 17 and Table 1 below:

TABLE 1

| Rotor IPD Angle | Parking Angle | |
|---|---|---|
| 330 to 30 degree | 30 | degree |
| 30 to 90 degree | 90 | degree |
| 90 to 150 degree | 150 | degree |
| 150 to 210 degree | 210 | degree |
| 210 to 270 degree | 270 | degree |
| 270 to 330 degree | 330 | degree |

In an embodiment, control logic 230 executes parking in the desired location by applying the appropriate drive signals the power switches of the power switch circuit 226 for a period that ensures completion of movement of the rotor. This period may be, for example, approximately 50-300 ms, in this example approximately 100 ms.

In an embodiment, control logic 230 generates SVPWM drive signals based on the rotor parking angle and drive the power switch circuit 226 accordingly. In an embodiment, control logic 230 may toggle between drive signals associated with neighbouring angles Vn and Vn+1 of a target angle in order to park the rotor at the target angle. For example, in order to park the rotor at 30 degrees, control logic 230 toggles between drive signals associated with 0-degrees (V1 in FIG. 13) and 60-degrees (V2 in FIG. 13) in successive cycles, thus driving VH and VL at a 50% duty cycle.

In an alternative embodiment, parking is executed using a combination of tables of FIGS. 13 and 16. In an embodiment, where IDP is executed using the table of FIG. 13, the parking voltage may be applied using the table of FIG. 16, (e.g., in order to park the rotor at 30 degrees, control logic 230 activates UH and WL signals of the power switch circuit 226). Similarly, where IDP is executed using the table of FIG. 16, the parking voltage may be applied using the table of FIG. 13 (e.g., in order to park the rotor at 60 degrees, control logic 230 activates UH, VH and WL signals of the power switch circuit 226).

### High Frequency Injection (HFI)

Open-loop frequency command start-up (step C) and low-speed control using HFI (step D) are described herein in detail, according to an embodiment.

In an embodiment, HFI is a process by which control logic 230 calculates the rotor position at low speed. HFI entails adding high-frequency voltage pulses to the drive voltage signals, and later extracting and measuring currents that correspond to the high-frequency voltage pulses from the motor current to detect the rotor position. Due to the high frequency and low magnitude, these voltage pulses do not carry sufficient current to drive the motor. However, their magnetic interaction with the rotor flux affects the current in a way that is sufficiently measurable by control logic 230 to calculate the rotor position.

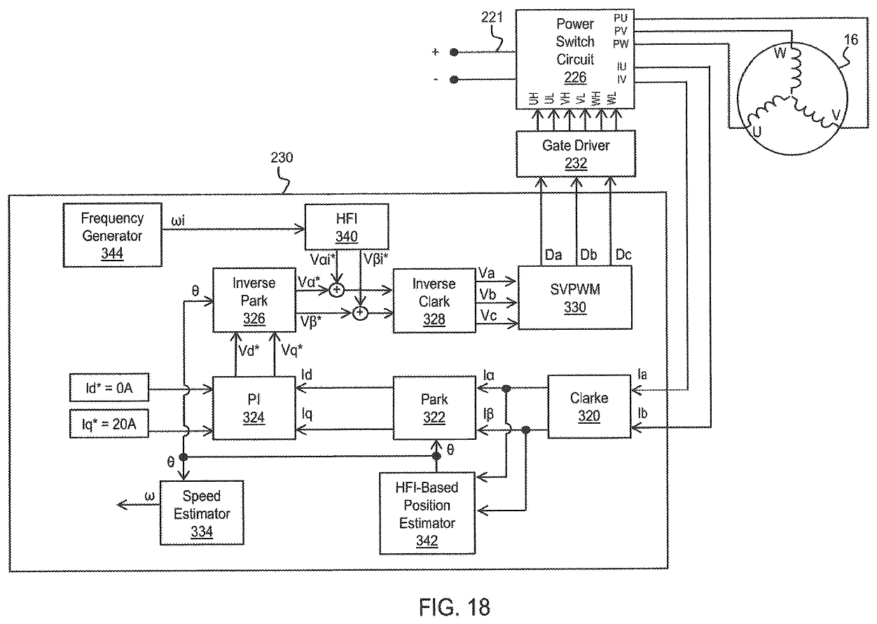

Referring to FIG. 18, a partial block system diagram of the power tool 10 in relation to high-frequency injection for low-speed control is depicted. This figure is similar to FIG. 10 and includes many of the same features, but control logic 230 is additionally provided with an HFI unit 340 and a frequency generator 344. Additionally, in this embodiment, the position estimator 332 of FIG. 10 is an HFI-based position estimator 342. These features are described here in detail.

In an embodiment, frequency generator 344 generates a sawtooth function ωi—also referred to as a frequency command—that sets the voltage frequency of the high-frequency voltage pulses. The frequency set by the frequency generator 344 may be pre-set according to motor size, type, power requirements, or other factors.

In an embodiment, the HFI unit 340 receives the frequency command, sets the magnitude of the high-frequency voltage pulses, and multiples the magnitude by the frequency command to generate high-frequency voltage waveforms Vαi* and Vβi* as follows:

$$V α i *= - V i * Sin ( ω i \cdot t )$$

$$V β i *= - V i * Cos ( ω i \cdot t )$$

where Vi is the amplitude of the injected voltage, ωi=2πfi, and fi is the injection frequency. In an embodiment, the injection frequency is between 1000 to 5000 Hz, preferably between 2000 to 4000 Hz, for example around 3000 Hz. In an embodiment, the Vi amplitude is approximately 20V for a 120V power supply (i.e., 1% of the DC bus 221 voltage), with a peak current of 2.2 A.

In an embodiment, the high-frequency voltage waveforms Vαi* and Vβi* generated by HFI unit 340 are substantially sinusoidal. The high-frequency voltage waveforms Vαi* and Vβi* are added to the stationary reference frame drive voltage signals Vα* and Vβ* generated by the inverse Park Transformation unit 326. The sums of the waveforms Vαi*+Vα* and Vβi*+Vβ* is provided to the inverse Clarke Transformation unit 328, which converts these 2-axis voltage signals to three phase voltage signals Va, Vb, and Vc, as previously discussed. The phase voltage signals PU, PV, PW provided to the motor from the power switch circuit 226 accordingly include high-frequency voltage components associate with Vαi* and Vβi*, as well as drive voltage components.

In an embodiment, HFI-based position estimator 342 extracts the high-frequency current components that are associated with HFI from the motor phase current signals. In an embodiment, HFI-based position estimator 342 receives current signals Iα and Iβ from the Clarke transformation unit 320. As previously discussed, current signals Iα and Iβ are sinusoidal waveforms that are 90 degrees apart resulting from execution of Clarke transformation on the three phase-current signals Ia, Ib, and Ic to obtain 2-axis coordinate system. HFI-based position estimator 342 retrieves high-frequency current components associated with the high-frequency voltages injected by HFI unit 340 from the current signals Iα and Iβ. HFI-based position estimator 342 uses the retrieved high-frequency current components to calculate the rotor position and output the rotor position signal θ. As previously discussed, rotor position signal θ is used by Park transform unit 322 to convert the Iα and Iβ to Id and Iq current components on a rotational reference frame, and by the Inverse Park transform unit 326 to convert the DC drive voltage signals Vd* and Vq* signals back to stationary reference frame drive voltage signals Vα* and Vβ*. Rotor position signal θ is also used by speed estimator 334 to calculate motor speed w.

In some examples, I_{q}* may be calculated as a PI function of the calculated speed ω and reference target speed ω*. It can however be important to ensure that the current I_{q}* is not so high that there is not sufficient bandwidth for injection of the high frequency voltage pulses. For example, it can be advantageous to configure the control logic such that, during HFI, the current I_{q}* is always lower than the maximum possible I_{q}* by an amount sufficient to allow injection (and subsequent detection) of the high frequency voltage pulses.

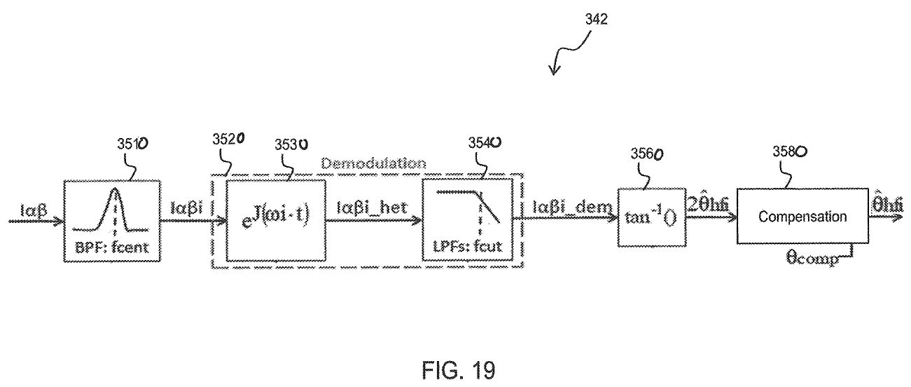

Referring to FIG. 19, a block system diagram detailing the HFI-based position estimator 342 is depicted, according to an embodiment. In an embodiment, HFI-based position estimator 342 receives current signals current signals Iα and Iβ (represented here as Iαβ) and uses a band-pass filter (BPF) 3510 to filter out currents outside a set frequency bandwidth. In an embodiment, the BPF 3510 has a centre frequency corresponding to the HFI 340 injection frequency (e.g., 3 kHz). This allows the HFI-based position estimator 342 to obtain high-frequency currents Iαβi associated with HFI.

In an embodiment, high-frequency currents Iαβi are then demodulated and filtered in demodulation unit 3520 to separate the rotor-induced currents from the HFI currents. Specifically, the high-frequency currents Iαβi are demodulated using Fourier Transform unit 3530 to obtain demodulated current signal Iαβi_het, where

$$Iαi\_het = Ii 0 \cdot Cos ( 2 ω \cdot t ) + Ii 1 \cdot Cos ( 2 θ )$$

$$Iβi\_het = Ii 0 \cdot Sin ( 2 ω \cdot t ) + Ii 1 \cdot Sin ( 2 θ )$$

and where Ii1·Cos(2θ) and Ii1·Sin(2θ) components are associated with rotor-induced currents, and Ii0·Cos(2ω·t) and Ii0·Sin(2ω·t) are associated with HFI currents.

In an embodiment, since the rotor-induced currents include the rotor angle information θ, the demodulated current signal Iαβi_het is then passed through a low-pass filter (LPS) 3540 to extract the rotor-induced currents represented as Iαβi_dem. A tan-inverse function unit 3560 applies a tan-inverse of (Iβi_dem/Iαi_dem) to calculate angle 2θ_{HFI} from the rotor-induced currents Iαβi_dem.

In an embodiment, angle 2θ_{HFI} has a range of 0-360 degrees for 0-180 degrees of rotor rotation. For example, if the rotor is at 90 degrees, 2θ_{HFI}=180, and if rotor is at 180 degrees, 2θ_{HFI}=360. Thus, angle 2θ_{HFI} is divided by 2 at compensation unit 3580. This is the reason why HFI has only a 180-degree rotor visibility. The angle is also compensated for at compensation unit 3580, where Qcomp is for example 60 degrees corresponding to phase shift due mainly to the LPF 354. The resulting output is HFI-estimated rotor angle θ_{HFI}.

It is noted that, in an embodiment, the division of 2θ_{HFI} by 2 is not a simple division; rather, this calculation involves monitoring the sample by sample difference of 2θ_{HFI} over time and calculating an integral of the sample differences to construct the rotor angle θ. This is because, as mentioned above, HFI has a rotor visibility of half the rotor position at any given point and ascertaining the exact rotor position that is not offset by 180 degrees requires sampling the rotor movement as well as present detected position.

The HFI process described above can be used by control logic 230 to accurately detect the rotor position at low speed (i.e., step D in process 400). However, when transitioning from the parking step (step B) to HFI at start-up, since the 2θ_{HFI} division process requires rotor rotation in order to accurately ascertain the correct rotor location, control logic 230 performs open-loop frequency command to start-up the motor at step C, described here.

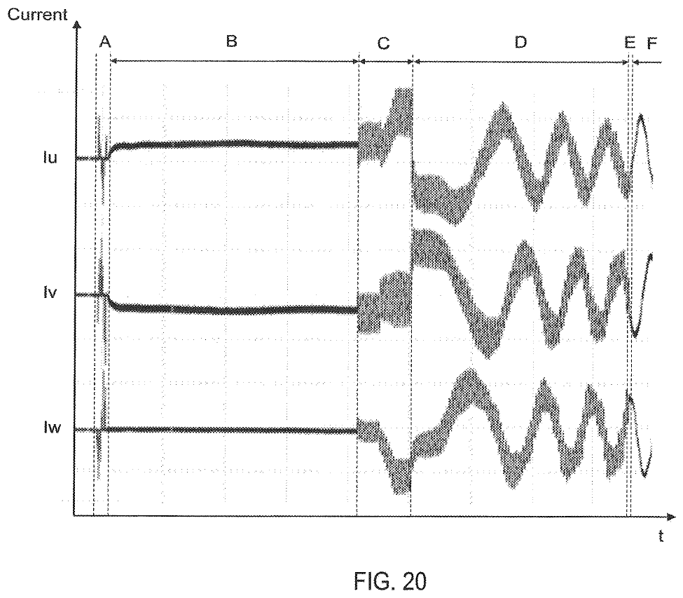

FIG. 20 depicts a current waveform diagram showing the three phase currents Iv, Iu, Iw as control logic 230 transitions through steps A-F. In an embodiment, in transitioning from the parking step (step B) to open-loop frequency command start-up (step C), control logic 230 begins to generate and apply HFI voltage to the motor while the parking force is still being applied. HFI-based position estimator 342 at this point begins to measure the motor current to calculate rotor angle 2θ_{HFI}, though as discussed above, this rotor angle θ_{HFI} has a range of 0-180 degrees and thus may be offset by 180 degrees.

To determine the correct rotor angle θ at start-up, control logic 230 compares the HFI-estimated rotor angle θ_{HFI} with the parking angle θ_{PARK}.

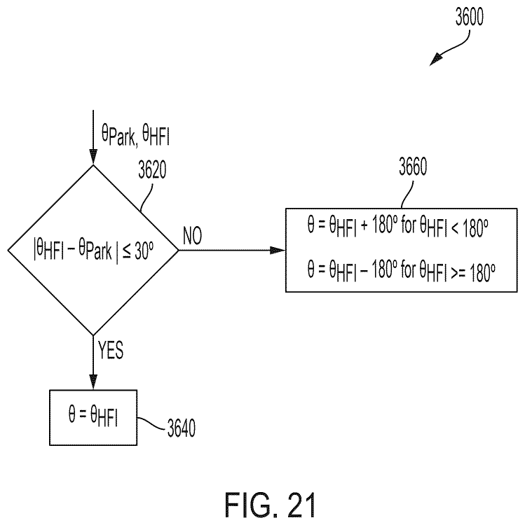

FIG. 21 depicts a flow diagram of a process 3600 executed by control logic 230 to determine the correct rotor angle θ at start-up, according to an embodiment. In an embodiment, control logic 230 compares the HFI-estimated rotor angle θ_{HFI} with the parking angle θ_{PARK} at step 3620. Controller sets the start-up rotor angle θ to θ_{HFI} if the estimated rotor angle θ_{HFI} is within a predetermined angle range of the parking angle θ_{PARK} (e.g., within 30 degrees of θ_{PARK}) at step 3640. If the estimated rotor angle θ_{HFI} is outside the predetermined angle range of the parking angle θ_{PARK}, control logic 230 sets the start-up rotor angle θ to θ_{HFI}+180 if θ_{HFI}<180 degrees, and to θ_{HFI}−180 if θ_{HFI}>=180 degrees at step 3660. This ensures that the start-up rotor angle θ is accurately calculated by HFI and is not off by 180 degrees.

Alternatively, If the estimated rotor angle θ_{HFI} is outside the predetermined angle range of the parking angle θ_{PARK}, control logic 230 simply sets the start-up rotor angle θ to θ_{PARK}. While the parking angle θ_{PARK} is not as accurate as the HFI angle θ_{HFI}, it is sufficiently accurate for execution of open-loop frequency command for motor start-up.

In an embodiment, control logic 230 simultaneously applies HFI and parking voltages to the motor for a relatively short period (e.g., 5-10 ms) to execute the above-described process 3600. Thereafter, control logic 230 removes the parking current and begin commutating the motor using in open-loop to kick-start the motor. This transition can be seen approximately half-way through step C in FIG. 20. Control logic 230 commutates the motor using fixed commutation commands beginning with the start-up rotor angle θ calculated as described above. This process continues until the rotor speed reaches approximately 2-4 rpm (e.g., 3 rpm), at which point the motor has sufficient speed for the compensation unit 3580 to accurately calculate the rotor angle θ. Control logic 230 then transitions to closed-loop HFI control for low-speed motor operation (step D).

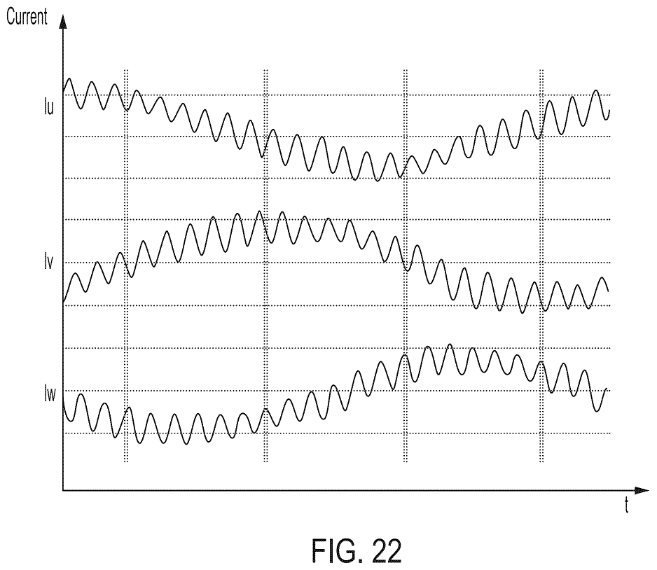

FIG. 22 depicts a zoomed-in view of FIG. 20 showing the three phase currents Iv, Iu, Iw as control logic 230 executes closed-loop HFI for low-speed motor operation (step D). This zoomed-in view covers approximately a full 360-degree motor rotation cycle. As shown here, HFI pulses are injected with low amplitude and high-frequency to the drive voltage signals, creating voltage ripples along the drive voltage sinusoidal waveform.

In an embodiment, control logic 230 continues the low-speed control using HFI (step D) until the HFI speed threshold is reaches. HFI speed threshold corresponds to the motor speed below which the motor does not generate sufficiently dependable back-EMF phase voltage that can be detected and reliably used by SMO process. Also, in some systems, HFI speed threshold may additionally correspond to the motor speed above which it is difficult to inject and process high-frequency voltages associated with HFI for calculation of motor position. The HFI speed threshold may vary depending on the motor and power tool size and power requirements.

### Sliding-Mode Observer

Once the rotor speed exceeds the HFI speed threshold, control logic 230 begins a transition process (step E) from HFI to SMO for measuring the rotor angle. Since HFI and SMO use different processes to measure rotor position, their rotor angle measurements at times do not match. A sudden transition from HIF to SMO therefore can cause a jolt in the rotor rotation, which should preferably be avoided.

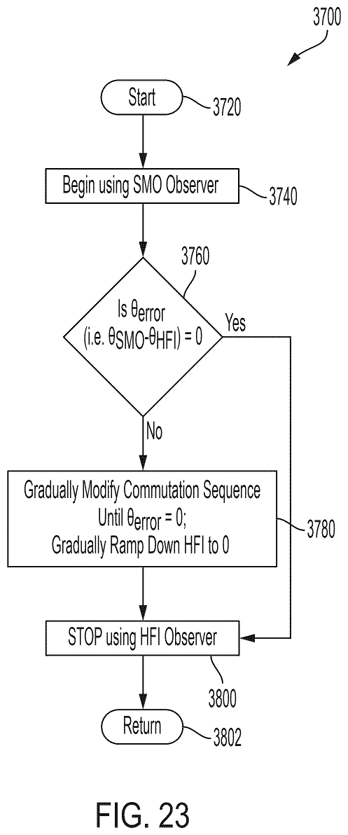

FIG. 23 depicts a flow diagram of a process 3700 executed by control logic 230 for transition from HFI to SMO (step E), according to an embodiment. In an embodiment, controller begins this process at 3720 and proceeds to start the SMO-based position estimator, which is discussed below in detail, at step 3740. The SMO-based position estimator begins to conduct the calculations needed to measure rotor speed θ_{SMO}. Control logic 230 is concurrently measuring rotor speed θ_{HFI} using the HFI process. At step 3760, control logic 230 calculates an error value θₑᵣᵣₒᵣ as the difference between θ_{HFI} and θ_{SMO} to determine if the two measurements match (or are at least sufficiently close to one another). If the measurements match, control logic 230 jumps to step 3800, where it stops using the HFI-based position estimator 342 and returns 3802 to process 400 shown in FIG. 12 at step E, where control logic 230 execute high-speed control using SMO (Step F) described below. If the two measurements don't match, at step 3780, control logic 230 gradually ramps up or down the motor commutation sequence until the two measured angles θ_{HFI} and θ_{SMO} match or are at least within a small margin of error. Concurrently, control logic 230 gradually ramps down the high-frequency injection process until is it fully stopped. Control logic 230 proceeds from step 3780 to step 3800. In an embodiment, process 3700 (i.e., step E) takes approximately 1-5 ms (in this example 2 ms).

Once the transition from HFI to SMO (step E) is complete, control logic 230 executes SMO alone for rotor angle measurement (step F).

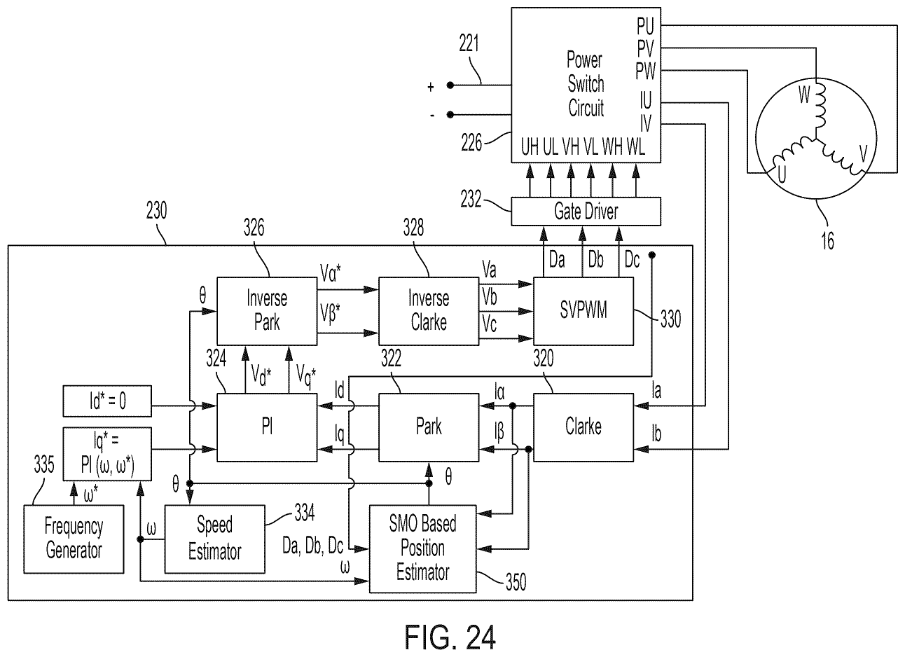

Referring to FIG. 24, a partial block system diagram of the power tool 10 is depicted. This figure is similar to FIG. 10 and includes many of the same features, where the position estimator is SMO-based position estimator 350. SMO is a process for estimating the motor back-EMF using the motor phase currents and calculating the rotor angle based on the motor back-EMF. SMO-based position estimator 350 receives the current signals Iα and Iβ from the Clarke transformation unit 320. As previously discussed, current signals Iα and Iβ are sinusoidal waveforms that are 90 degrees apart resulting from execution of Clarke transformation on the three phase-current signals Ia, Ib, and Ic to obtain 2-axis coordinate system. SMO-based position estimator 350 also receives drive signals Da, Db, and Dc from the output of SVPWM unit 330, as well as the bus voltage signal 221 and motor speed signal ω from speed estimator 334, to calculate the motor voltage being applied to the motor. By comparing the applied voltage and the measured motor current, SMO-based position estimator 350 is able to retrieve the motor back-EMF voltage and use it to calculate the rotor angle θ.

In an embodiment, Id* is set to 0 and Iq* is calculated as a PI function of the calculates motor speed ω and the target speed reference signal ω* generated by frequency generator 335, as previously discussed.

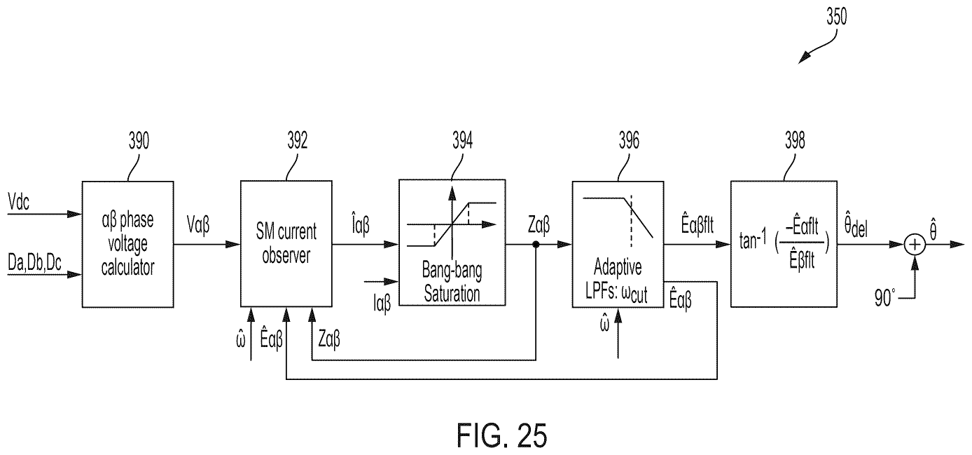

Referring to FIG. 25, a block system diagram detailing the SMO-based position estimator 350 is depicted, according to an embodiment. In an embodiment, SMO-based position estimator 350 receives current signals Iα and Iβ (represented here as Iαβ), motor speed signal ω, DC bus voltage Vdc, and drive signals Da, Db, and Dc. SMO-based position estimator 350 includes an αβ phase voltage calculator 390 that multiplies the bus voltage Vdd by the drive signals Da, Db, and Dc and obtain sinusoidal voltage signals representing the motor drive voltage. αβ phase voltage calculator 390 also conducts a Clarke transformation on the sinusoidal voltage signals to generate 2-axis sinusoidal voltage waveforms Va and VB (here represented as Vαβ). SMO-based position estimator 350 further includes a Sliding-Mode (SM) current observer 392 that combines the voltage signals Va and VB with the motor speed signal ω, as well as two feedback signals Eαβ and Zαβ, to generate Îαβ. Eαβ represents the calculated motor back-EMF, Zαβ represents the flux linkage, and Îαβ is the estimated (i.e, predicted) phase current that should be passing through the motor based on these inputs. SMO-based position estimator 350 includes a bang-bang/saturation unit 394 that calculates the flux linkage Zαβ in such a way so as to the minimize the error (difference) between Îαβ and Iαβ. In other words, bang-bang/saturation unit 394 repeatedly modifies the flux linkage Zαβ in the feedback loop to SM current observer 393 until the Îαβ is equal to Iαβ. The resulting flux linkage Zαβ measurement is provided to adaptive low-pass filters (LPF) 396, which receive the motor speed ω and calculate the motor back-EMF as a function of flux voltage (which depends on motor speed) as follows:

$$Back - EMF = - d ( Z αβ ) / dt$$

A tan-inverse unit 398 calculates angle θdel as a tan-inverse function of the calculated back-EMF voltages Eαflt and Eβflt. This angle is compensated for by a compensation angle (in this example 90 degrees) corresponding to phase shift due mainly to the LPF 396 to obtain SMO-estimated rotor angle θ.

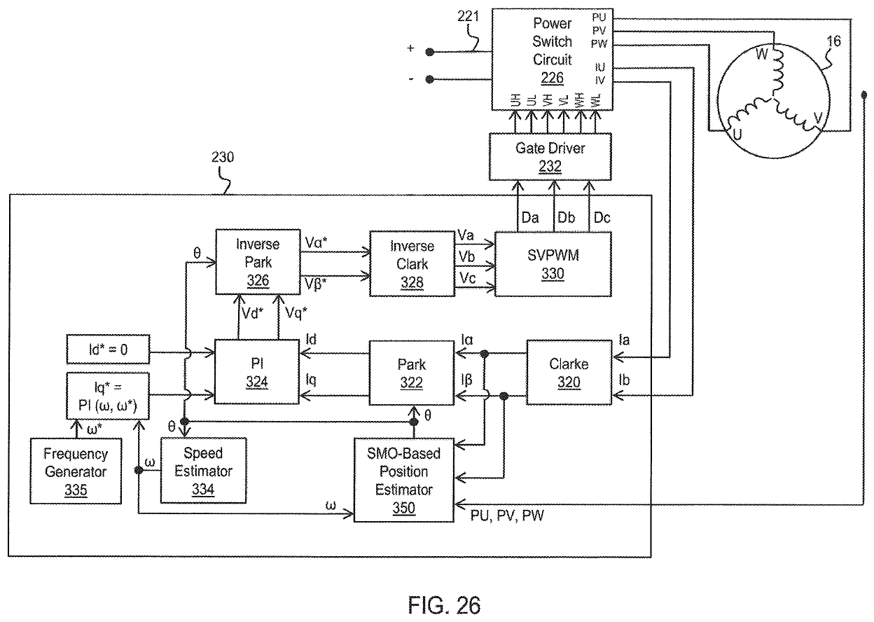

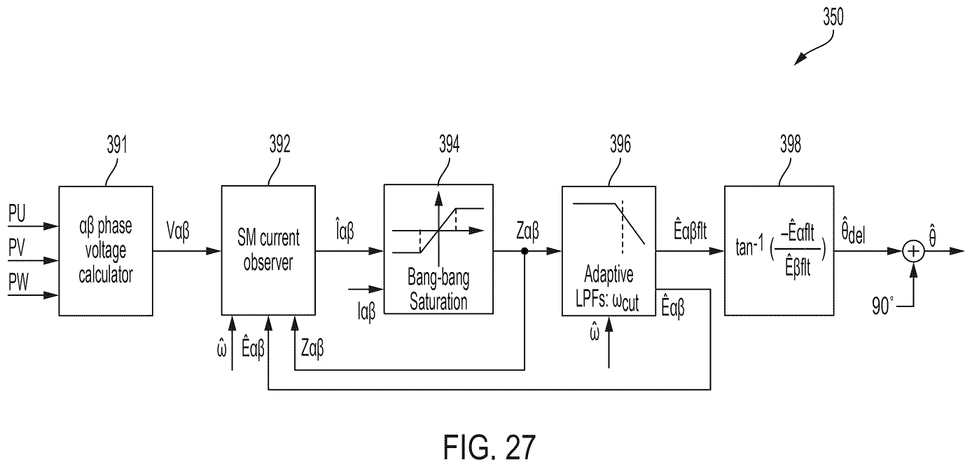

FIGS. 26 and 27 depict a partial block system diagram of the power tool 10 using an alternative SMO execution technique, and block system diagram detailing the alternative SMO-based position estimator 350 respectively, according to an embodiment. As shown in these figures, in this embodiment, SMO-based position estimator 250 does not calculate the motor phase voltages based on DC bus voltage Vdc and drive signals Da, Db, and Dc. Rather, SMO-based position estimator 250 receives the motor phase voltage signals PU, PV, and PW directly from the motor 16. SMO-based position estimator 350 includes an αβ phase voltage calculator 391 that receives the phase voltage signals PU, PV, and PW and constructs 2-axis sinusoidal motor voltage waveforms Vα and Vβ (here represented as Vαβ) accordingly. The rest of the SMO process is similar to FIGS. 24 and 25 described above.

In an embodiment, the SMO equation described above is represented as follows:

$$\frac{{di}_{α - β}}{dt} = - \frac{Rs}{Ld - Lq} ∓ {ω}_{e} * \frac{( Ld - Lq )}{Ld} * {i}_{α - β} + \frac{1}{Ld} ( {u}_{α - β} - {e}_{α - β} )$$

where uα−β corresponds to the motor phase voltages, iα−β represents the measured motor phase current, Rs is the per-phase stator resistance, Ld is the direct axis stator per-phase inductance, Lq is the quadrature axis stator per-phase inductance, and eα−β=∓Eext (sin θe/cos θe) corresponds to the extended back-EMF of the motor. The SMO-based Position Estimator 350 estimates eα−β for a given iα−β and uα−β and calculates the position of the rotor as a function of tan⁻¹(eα/eβ).

In an embodiment, control logic 230 executes SMO for high-speed operations up to the maximum tool speed. In an embodiment, control logic 230 may implement hysteresis threshold value above or below the HFI threshold for transitioning back to HFI when the motor speed falls.

In an embodiment, control logic 230 used for FOC execution and rotor position detection is a 32-bit processor employing an ARM Cortex-M0+ processor core. A Cortex-M0+ processor core includes a two-stage pipeline architecture and is therefore cheaper and consumes less power than other ARM Cortex-M processors. Based on conventional wisdom, Cortex-M0+ processors are considered too slow to handle the processing power requires for FOC execution and rotor position detection, particularly in high-speed and/or high-torque motor control applications where the rotor angle can change very quickly in an unexpected manner. However, in an embodiment, by removing the Hardware Abstraction Layer (HAL) of the processor core, which provides a programming interface that allows the processor to interact with hardware resources, and customizing the related registers accordingly, Cortex-M0+ processors can be used to implement the techniques described above for power tool applications. Efficient rotor detection schemes described above have proven to be capable of execution by Cortex-M0+ processors. In particular, parking and open-loop frequency command start-up (steps B and C) prior to HFI, as well as the transition step from HFI to SMO (step E), provide for more accurate and efficient detection of rotor position without requiring significant processing power conventionally required. It should be noted, however, that more powerful processors, e.g. Cortex-M1, Cortex-M2, etc. may be alternatively utilized.

The motor control apparatus, control logic and power switch circuit of FIGS. 3, 6, 18, 24, 26 are shown as comprising a number of functional blocks. This is schematic only and is not intended to define a strict division between different logic elements of such entities. Each functional block may be provided in any suitable manner.

Generally, any of the functions, methods, techniques or components described above can be implemented in software, firmware, hardware, or any combination thereof. The terms “module,” “functionality,” “component”, “element”, “unit”, “block” and “logic” may be used herein to generally represent software, firmware, hardware, or any combination thereof. The algorithms and methods described herein could be performed by one or more processors executing code that causes the processor(s) to perform the algorithms/methods. Examples of a computer-readable storage medium include a random-access memory (RAM), read-only memory (ROM), an optical disc, flash memory, hard disk memory, and other memory devices that may use magnetic, optical, and other techniques to store instructions or other data and that can be accessed by a machine.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein. In view of the foregoing description it will be evident to a person skilled in the art that various modifications may be made within the scope of the invention.

1. A start up method for an electric motor configured to drive a mechanical load in a reciprocating or oscillating cycle, the method being for use in a power tool and comprising:
setting a first target speed ramp for the motor having a first gradient;
monitoring a drive parameter indicative of the power and/or torque generated by the motor;
detecting a maximum in the drive parameter; and
in response to detecting the maximum, setting a second target speed ramp for the motor having a second gradient that is greater than the first gradient.

2. The method of claim 1, wherein the motor is coupled to a reciprocating drive mechanism of the power tool such that, in use, rotation of the motor corresponds to movement of the mechanical load through the reciprocating cycle.

3. The method of claim 1, wherein the power tool is a compacting power tool without a clutch between the motor and the reciprocating drive mechanism.

4. The method of claim 1, wherein the mechanical load comprises, in use, one or more of: mechanical load of a compacting foot of the compacting power tool on a surface to be compacting; mechanical load of one or more biasing elements of the reciprocating drive mechanism; weight of at least part of the compacting power tool.

5. The method of claim 1, wherein the power tool and/or its load is configured such that, in use at a steady-state motor speed, the input power to the motor required to maintain the steady-state motor speed varies over the reciprocating or oscillating cycle.

6. The method of claim 1, wherein the power tool comprises one or more biasing elements arranged to store and release energy during the reciprocating or oscillating cycle driven by the motor.

7. The method of claim 6, wherein, in use, the action of the one or more biasing elements during the reciprocating or oscillating cycle causes a variation in motor speed over the reciprocating or oscillating cycle for a fixed power input from the motor.

8. The method of claim 1, wherein, in use, the action of gravity on the power tool during the reciprocating or oscillating cycle causes a variation in motor speed over the reciprocating or oscillating cycle.

9. The method of claim 1, further comprising controlling commutation of the motor in accordance with the target speed according to the first/second target speed ramp.

10. The method of claim 9, wherein the motor is a three-phase motor and the controlling commutation of the motor is performed according to a Field-Oriented Control (FOC) scheme, Trapezoidal 6-step control scheme, or a V/Hz control scheme.

11. The method of claim 1, wherein the setting of the second target speed ramp is performed independently of a measured speed of the motor.

12. The method of claim 1, wherein the gradient of the second target speed ramp is at least twice the gradient of the first target speed ramp, or at least five times the gradient of the first target speed ramp.

13. The method of claim 1, wherein the gradients of the first and second target speed ramps are an average rate of change of the respective target speed ramp over a predetermined period of time or the period of time over which the respective target speed ramp applies to the motor.

14. The method of claim 1, wherein the drive parameter is a quadrature current I_{q} in the rotating frame of reference of the motor synchronous with the rotor flux.

15. The method of claim 1, wherein the detecting a maximum in the drive parameter comprises:
filtering the drive parameter so as to suppress and/or remove variations in the drive parameter above a predetermined frequency; and
identifying a maximum of the drive parameter.

16. The method of claim 15, wherein the predetermined frequency is at least twice the steady state frequency of the motor in use when driving its mechanical load in the reciprocating or oscillating cycle.

17. The method of claim 15, wherein identifying a maximum of the drive parameter comprises:
detecting a rate of change of zero in the drive parameter; and
confirming that the zero rate of change of the drive parameter represents a maximum of the drive parameter.

18. The method of claim 1, further comprising, subsequent to setting the second target speed ramp, setting a steady-state target speed for the motor when the motor reaches a predetermined speed.

19. The method of claim 18, wherein the steady-state target speed is user selectable.
